(19) United States
(12) Patent Application Publication
(10) Pub. No.: US 2002/0087679 A1
(43) Pub. Date: Jul. 4, 2002

(54) Systems and methods for monitoring website activity in real time

(75) Inventors: Harry C. Pulley, Guelph (CA); Michael H. Chapman, Guelph (CA); Sandra Loop, Waterloo (CA); Phillippe F. Bertrand, Kitchener (CA); Thomas B. Kapler, Toronto (CA)

Correspondence Address: OLIFF & BERRIDGE, PLC, P.O. BOX 19928, ALEXANDRIA, VA, 22320, US

(73) Assignee: Visual Insights

(21) Appl. No.: 09/753,602

(22) Filed: Jan. 4, 2001

(51) Int. Cl. G06F 15/16; G06F 15/173

(52) U.S. Cl. 709/224; 709/229

(57) ABSTRACT

Tracking customers is easier in cyberspace than in the brick-and-mortar world. Unfortunately, customer traffic through a website cannot be readily observed. In the systems, methods and data visualization metaphors of this invention, one or more instrumentation techniques are used to capture website activity data in real-time. This website activity data is provided to an aggregation subsystem that stores hits matching monitored web pages into one or more contexts. Each context is implemented as one or more independent data structures that contain configuration information and that are usable to capture and store hit data for web pages that are relevant to the monitoring task. The stored hit data is visualized using any one of a number of different visual metaphors, such as a “floor-and-back wall” visualization metaphor. In various exemplary embodiments of this visualization metaphor, distinct portions of the context are organized as “aisles” on the “floor” of a 3-dimensional space. The website activity, such as, for example, hits on monitored pages, is displayed as 3-dimensional objects whose height represents the amount of website activity for a current “tick”. Previous values of the website activity are shown as 2-dimensional graphs that “tail” from the 3-dimensional objects. Movement by visitors between monitored web pages is visualized by transferring 3-dimensional objects between source and destination objects that represent the number of visitors leaving one page for another page. A back wall of the 3-dimensional space is used to display graphical data, such as flow graph charts, graphs, and/or pie charts.

### BACKGROUND OF THE INVENTION

1. Field of Invention

This invention relates to systems and methods for visualizing data related to activity on a node of a distributed network.

2. Description of Related Art

As the ubiquity of the Internet expands into nearly every imaginable business process, the pace of business has dramatically increased. Thus, decisions need to be made faster than ever. Similarly, when events occur, the marketplace demands a response with increased urgency. This is particularly true for e-businesses and companies involved in e-commerce. From the customers' perspective, one of the greatest strengths of a distributed network such as the Internet, and especially the World Wide Web, is that such distributed networks eliminate time and distance. In particular, the World Wide Web has moved most retailing closer to a self-service economy. This results, in part, from the fact that every e-commerce site is opened 24 hours a day, seven days a week, 365 days a year. That is, there are no off hours.

Moreover, on distributed networks, including the World Wide Web, the distance between any two nodes of such a distributed network, such as the nodes of two competing businesses, is not measured in miles or time, but in the number of key strokes and mouse clicks that it takes a customer to move between the nodes for those two businesses. Thus, in cyberspace, comparison-shopping is instantaneous. Switching retailers or vendors can be as easy for a customer to accomplish as entering a new bookmark, adding a shipping address, and entering a credit card number.

The opportunity to track customers and spending patterns is also increased in cyberspace. In the brick and mortar world, a department store operator might know by matching credit card numbers that a customer, for example, purchased a tie from the men's department and dress shoes from the shoe department. A department store operator often can also visually examine the activity on the floor of the department store. Cameras or offices located above the department store floor can give the department store operator a “bird's-eye” view. The bird's-eye view allows the department store operator to follow flow patterns among the departments, find high activity areas, identify aisle obstructions, and identify under-utilized sections of the department store. From this overview, the department store operator often can determine overall store activity. From experience, department store operators know that overall store activity correlates well with transaction activity.

### SUMMARY OF THE INVENTION

It should be appreciated, for the following discussion of the various exemplary embodiments of the systems and methods according to this invention, the term “website” is meant to encompass not only sites on the World Wide Web, but any other known or later-developed node or unique portion of a distributed network. Similarly, the term “node of a distributed network” is intended to encompass static websites, dynamic websites, distributed websites, any other known or later-developed types of websites, and any other known or later-developed identifiable portion of a distributed network.

Unfortunately, unlike the brick-and-mortar world, the operator of a node on a distributed network, such as a website, whether directed to e-commerce or merely to providing customers with sales and other general types of information, cannot readily observe the customer traffic in, out, and/or through the various pages of the website, at least not directly. U.S. Provisional Patent Application Nos. 60/201,761, 60/201,737 and 60/206,557, each incorporated herein by reference in its entirety, disclose systems and methods for parsing and data-mining website activity logs. While the various systems, methods and data visualization metaphors disclosed in these incorporated applications provide powerful tools for visualizing website activity, they are directed at visualizing historical data in an off-line manner, i.e., not in real time.

This primarily occurs because the website activity logs are normally accessed and parsed usually only once a day or less. Thus, by the time the website activity logs are provided to the website activity log parsing and data mining systems and methods disclosed in the incorporated applications, sufficient time has passed such that, while valuable historical analysis can be performed on the website activity data, it is no longer possible to react in a real-time or a near-real-time manner to the website activity data captured in the website activity logs.

In particular, website activity logs have empowered vendors in much the same way that the basic Internet and World Wide Web technology have empowered customers. The most striking change is that the website activity logs and other conventional methods for capturing customer data provide vast amounts of “fine-grained” data about visitors to websites. For example, every click, page view, purchase, branded purchase, and the like is captured by website instrumentation. Thus, while a brick-end-mortar department store operator may be able to match various purchases by credit card number, an e-commerce retailer on the World Wide Web would know, for example, that that particular customer looked at several silk ties before finally selecting one, tried to find a matching shirt, gave up, and later came back to buy shoes.

For both e-commerce websites and web-based initiatives at traditional firms and retailers, the key question is how to quickly and accurately monitor site-movement, track and identify patterns, and ultimately use this data effectively to enable business decisions. As businesses collect and store more information, it actually becomes more difficult to detect and identify patterns and trends in the collected information. Moreover, once the patterns and trends are discerned and identified, it is often difficult to understand how that information can be used to improve the business.

There is no question that the information is there to be mined. The degree of instrumentation available in e-commerce and e-business is astounding. Memory and storage costs have decreased so much that it is now possible for web-based systems to literally collect fine-grained data on every customer interaction, no matter how small or trivial. However, accessing and using this fine-grained data to power real-time strategic and tactical decisions is essentially impossible using conventional techniques. At the broad level, the best strategies for improving e-business and e-commerce performance are the same as those for general businesses. The best companies follow a three-phase process of measuring business systems, analyzing the gathered information, and acting on the information and the analyses, then repeating the process incorporating the new information. The difference today is that businesses have the technology to measure business information down to the minute, but are lacking in technology to allow that information to be analyzed and acted upon in anything approaching a real-time manner.

In web-based marketing campaigns, companies can and do change content, adjust banner ads, modify e-mail messaging, and change website content literally throughout each day. Businesses thus must understand campaign productivity as it occurs and make adjustments on the fly. This involves measuring how different stimuli affect site traffic flows, site stickiness, entry and exit points, and, for e-commerce sites, relating this activity directly to buying behavior. For example, there is no point in stimulating more demand for a promotion if inventory is running low, if the site is experiencing technical problems and/or if a weather pattern or other outside events will delay product shipments. Increasing demand in such cases, given the ease in which customers can and do switch to competing retailers in the face of even small inconveniences, will have significant negative effects on the business.

This invention provides systems and methods that allow website activity to be monitored in real-time or near real-time.

This invention separately provides systems and methods for aggregating website activity data from a plurality of users in real-time or near real-time.

This invention additionally provides systems and methods that allow the aggregated data to be broken down into meaningful subsections that allow website activity within a website to be meaningfully monitored.

This invention separately provides systems and methods for visualizing website activity in real-time and/or near real-time.

This invention separately provides systems and methods for visually comparing historical website activity data with real-time and/or near real-time website activity data.

This invention separately provides systems and methods for visualizing movement of customers and other web-site users within a website in real-time and/or near real-time.

This invention separately provides systems and methods for visualizing flow into and out of selected portions and/or pages of a website in real-time and/or near real-time.

This invention separately provides systems and methods for visualizing performance indicators for a selected portion or page of a website in real-time and or near real-time.

This invention separately provides systems and methods for visualizing website activity for a selected portion or page of a website based on one or more advertising campaigns in real-time and/or near real-time.

In various exemplary embodiments of the systems, methods and data visualization metaphors according to this invention, activity of a monitored node of a distributed network is collected in real-time or near real-time. In some exemplary embodiments of the systems methods and data visualization metaphors according to this invention, a “filter” is placed in the web server or servers for the monitored website. The web server “filter” receives the hits to the monitored website as fast as the web server or servers process the hits. The web server “filter” sends the monitored hits directly to the aggregation system.

In various other exemplary embodiments, near real-time monitoring of the monitored website is performed by accessing the website activity log file immediately upon the server writing the website activity log data to it. Website activity log data is cached by the web server or servers and is periodically “flushed” from the cache to the website activity log file. If the flush time is sufficiently short, then near-real-time monitoring of the monitored website is possible. Moreover, old website activity logs can be accessed as if they were new data and played back at various speeds to visualize the historical data as it was created. Additionally, the data from a historical website activity log can be displayed along with the current real-time or near-real-time data, however gathered. This allows comparisons of the real-time and/or near-real-time data to the historical data recorded in the website activity logs to be performed.

Finally, in yet other various exemplary embodiments according to this invention, the monitored website can include scripts, ASP or Javascript, or the like on some or all of the web pages of the monitored website. Thus, when any web page containing such a script or the like is accessed, the script ASP, Javascript or the like executes. The scripts are specifically designed to provide website activity data directly to an instrumentation server that is designed to record the information provided by the scripts.

In various exemplary embodiments of the systems, methods and data visualization metaphors according to this invention, the website activity data, however gathered, is provided to an aggregation subsystem. In various exemplary embodiments, the aggregation subsystem stores hits that match web pages to be monitored into contexts. In various exemplary embodiments, the aggregation subsystem is capable of maintaining multiple contexts.

In various exemplary embodiments of the systems, methods and data visualization metaphors according to this invention, each context is implemented as one or more interdependent data structures that contain configuration information and that are usable to capture and store hits to pages that the user has indicated are relevant to that user's monitoring task. The one or more data structures of each context are independent of the one or more data structures of any other context. By allowing multiple contexts to be defined and active in the aggregation subsystem, multiple sets of watchlists can be independently and concurrently monitored by the aggregation subsystem.

In various other exemplary embodiments of the systems, methods and data visualization metaphors according to this invention, a single set of watchlists representing the union of each context's set of watchlists is monitored, rather than monitoring several independent sets of watchlists.

The contexts are recorded along with associated ad campaign identifiers, user identifiers, such as cookies and/or IP addresses. In various exemplary embodiments, hit attempts that result in error messages, rather than the requested web pages, being returned to the user, are also stored in contexts.

In various exemplary embodiments, the aggregation subsystem stores and outputs clickstream information. If configured to do so, the data aggregation system can also store this information into a real-time click data repository. This information may be used later by various data visualization and analysis modules, such as those disclosed in the previously incorporated applications. The “tick” represents all the activity that happened within the monitored website within one “tick” of the “clock” of the aggregation subsystem.

In various exemplary embodiments of the systems, methods and data visualization metaphors according to this invention, the tick list and context list data is visualized using any one of a number of different visual metaphors. In general, the particular visual metaphor used to visualize the tick list and context list data will depend on the particular purpose to which the website is being used. In various exemplary embodiments of e-commerce-oriented websites, a “floor-and-back wall” visualization metaphor is used. In various exemplary embodiments of this floor and backwall visualization metaphor, the context lists are organized as “aisles” on the “floor” of a 3-dimensional space. In various exemplary embodiments, a back wall of the 3-dimensional space is used to display 2-dimensional graphical data, such as flow graph charts, graphs, pie charts, and the like.

In various exemplary embodiments of the data visualization metaphors according to this invention, website activity, such as, for example, hits on monitored pages, is displayed as 3-dimensional objects whose height represents the amount of website activity on each monitored page or defined subset of pages of the website for the current “tick”. Each such defined subset of pages is called a “category” or “watchlist” in the following description of obvious exemplary embodiments of the systems and methods according to this invention. Previous values of the website activity for each monitored page, watchlist, or category are shown as a 2-dimensional graph that “tails” from the cylinder.

In various exemplary embodiments of the systems methods and data visualization metaphors according to this invention, movement by users of the monitored website between monitored web pages, watchlists or categories is visualized by transferring 3-dimensional objects between source and destination objects. In this case, the 3-dimensional objects represent the number of users leaving one website watchlist, category, or page and going to another monitored website watchlist, category, or page. As a result, the 3-dimensional objects representing the current activity of each monitored website watchlist, category, or page increase by the volumes of the 3-dimensional objects that it receives and decreases by the volumes of the 3-dimensional objects that it transmits.

These and other features and advantages of this invention are described in, or are apparent from, the following detailed description of various exemplary embodiments of the systems, methods and data visualization metaphors according to this invention.

### BRIEF DESCRIPTION OF THE DRAWINGS

Various exemplary embodiments of the systems, methods and data visualization metaphors of this invention will be described in detail, with reference to the following figures, wherein:

FIG. 1 is a block diagram outlining a generalized structure of one exemplary embodiment of a website activity monitoring and visualizing system according to this invention;

FIG. 2 is a block diagram outlined a first exemplary embodiment of a website activity monitoring and a visualizing system according to this invention;

FIG. 3 is a second exemplary embodiment of a website monitoring and visualizing system according to this invention;

FIG. 4 is a third exemplary embodiment of a website activity monitoring and visualizing system according to this invention;

FIG. 5 is a block diagram outlining in greater detail one exemplary embodiment of the aggregation subsystem according to this invention;

FIG. 6 is a block diagram outlining in greater detail one exemplary embodiment of the data server according to this invention;

FIG. 7 is a block diagram outlining in greater detail one exemplary embodiment of the visualizing subsystem according to this invention;

FIGS. 8 and 9 show two instances of one exemplary embodiment of a data visualization metaphor for visualizing real-time or near-real-time data according to this invention;

FIG. 10 shows in greater detail one exemplary embodiment of a visual metaphor for representing current and past real-time data according to this invention;

FIG. 11 shows in greater detail a portion of the “floor” of FIG. 8;

FIGS. 12 and 13 show two instances of one exemplary embodiment of a graphical representation of flow within a selected portion of the monitored website according to this invention;

FIGS. 14 and 15 show two instances of a first exemplary embodiment of a graphical representation usable to display key performance data of a selected portion of the monitored website;

FIG. 16 shows one exemplary embodiment of a graphical representation usable to visualize advertising campaign-related data according to this invention;

FIG. 17 shows a second exemplary embodiment of the data visualization metaphor according to this invention; and

FIGS. 18 and 19 illustrate a number of alternative 3-dimensional objects usable to visualize the real-time or near-real-time data of the monitored website.

### DETAILED DESCRIPTION OF EXEMPLARY EMBODIMENTS

It should be appreciated, for the following discussion of the various exemplary embodiments of the systems and methods according to this invention, the term “website” is meant to encompass not only sites on the World Wide Web, but any other known or later-developed node or unique portion of a distributed network. Similarly, the term “node of a distributed network” is intended to encompass static websites, dynamic websites, distributed websites, any other known or later-developed types of website, and any other known or later-developed identifiable portion of a distributed network.

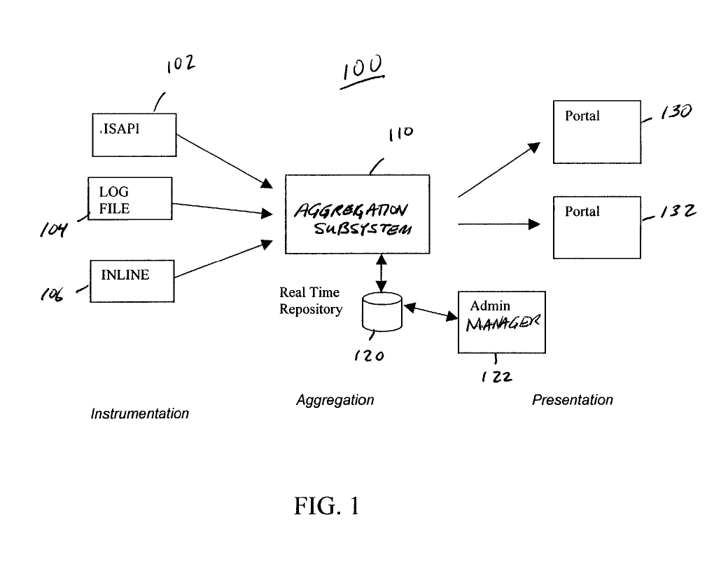

FIGS. 1-4 show various exemplary embodiments of a system that monitors website activity according to this invention. As shown in FIGS. 1-4, the website activity monitoring systems 100-300 according to this invention perform three main functions. First, the website activity monitoring systems 100-300 according to this invention perform instrumentation of hits on the monitored website. Secondly, the website activity monitoring systems 100-300 according to this invention aggregate those hits into small convenient packages suitable for transport across distributed networks. Finally, the website activity monitoring systems 100-300 according to this invention take those packages of data and presents and visualize the data packages in a three-dimensional landscape. This three-dimensional landscape allows selection, brushing, such as mouse-over brushing, in-context detail drilldown brushing, and other brushing techniques, and selection drill-down. This three-dimensional landscape also uses time-series displays and animation to allow a user to visualize the activity on the website at various levels and to visualize movement into, through and out of the website.

In contrast to the previously incorporated applications, which are focused towards in-depth analysis of historical data, as opposed to real-time or near-real-time data, the website activity monitoring systems, methods and visual metaphors according to this invention are focused on monitoring activity. By monitoring activity, a user becomes able to identify any immediate effects due to changes made to one or more pages, watchlists and/or categories of a website or in view of the release of one or more special ad campaigns. Similarly, the website activity monitoring systems, methods and visual metaphors according to this invention show in real-time or near-real-time the effectiveness of different or identical ads placed at the same or different web portal sites or web pages, watchlists or categories, so that the differential effects of these ads can be discerned.

The website activity monitoring systems, methods and visual metaphors according to this invention can illustrate how different website structures affect traffic through the website, such as whether index pages or search pages are getting more use. The user of the website activity monitoring systems, methods and visual metaphors according to this invention can see how in-site up-sell and side-sell banner ads drive visitors to the website to place more things into the visitors' shopping baskets, so that locations where changes or additions might be fruitful can be identified.

Likewise, the website activity monitoring systems, methods and visual metaphors according to this invention allow the dwell time for each monitored page, watchlist and/or category of the website to be measured and displayed. Thus, a user can identify areas where content may need to be updated or modified. Should product information be available, the website activity monitoring systems, methods and visual metaphors according to this invention can be used to identify the cash flow currently being generated by each product displayed in the website.

However, unlike the in-depth analysis provided by the incorporated applications, the website activity monitoring systems, methods and visual metaphors according to this invention generally do not differentiate between browsing visitors, buying visitors and abandoning visitors. This occurs because, when monitoring the website activity in real-time or near-real-time, any open shopping basket remains a potential sale.

FIG. 1 is a block diagram illustrating a high level abstraction of a website activity monitoring system according to this invention. As shown in FIG. 1, in the website activity monitoring system 100, one or more website activity instruments 102-106 are used to identify hits to various web pages within the monitored website. Each of the instruments 102-106 provides hit data to the aggregation subsystem 110. The aggregation subsystem 110 aggregates all of the hits that occur within a sample window, or “tick”, and compares the aggregate number of hits to each web page within the sample interval to one or more contexts or analysis sessions. At the same time, the aggregation subsystem can store the raw and/or aggregated data into a real-time repository 120.

The real-time repository also stores configuration data that is used to configure the website. In various exemplary embodiments, the configuration data includes the various web pages to be monitored, and collections of the monitored web pages organized as watchlists and/or categories, and the various operations that a visitor must pass through to purchase a product from the website. The configuration data also includes other website-specific information, such as the current advertising campaigns that are being used to drive traffic to the monitored website, the errors that the website operator wishes to monitor, and the like. As shown in FIG. 1, the configuration and other administrative data stored in the real-time repository 120 is entered using an administration manager 122.

After the aggregation system 110 aggregates the website activity data and updates the various contexts or analysis sessions, the data is ready to be pulled from the aggregation subsystem 110 by any active visualization portals 130 and/or 132. Each visualization portal 130 or 132 can visualize a particular context or analysis session. That is, the particular web pages that are being monitored and the hierarchical organization of those web pages in the visualization metaphor is specific to each visualization portal 130 or 132.

Thus, for example, a user who wishes to monitor the sales activity generated by an e-commerce website can use one context or analysis session running in the first visualization portal 130, while an information technology specialist, who wishes to determine the real-time system resource utilization of the website, can open a second context or analysis session in the second data visualization portal 132. In this case, the aggregation subsystem 110 will update, for each sample interval or tick, the various web pages, watchlists, and/or categories that each user has determined need to be monitored for each particular context.

In the website activity monitoring systems, methods and data visualization metaphors according to this invention, hit level data must be captured to enable real-time or near-real-time website monitoring. This hit level data can be captured directly from the web server using a “filter”, indirectly from the web server by tailing the web activity log file as the web server writes the web activity data to the web activity log file, and/or the hit data may be gathered from a separate server that is specifically designed to respond to specially-instrumented web pages as such web pages are accessed by visitors. It should also be appreciated that, while the website activity monitoring systems, methods and visual metaphors according to this invention are primarily directed to visualizing real-time or near-real-time website activity, the hit level data may be historical data that the user wishes to visualize in real-time and is thus gathered from a database where historical page hit data has been stored.

In general, in various exemplary embodiments, the hit level data information is captured for raw page hits, errors, shopping basket and other checkout events, and the like. In general, any particular event within the standard website activity log data can be monitored, as well as special activities or actions if in-line instrumentation, as discussed below, is used. It should be appreciated that, as outlined briefly above, tracking of shopping basket and other checkout events is implementation-dependent and thus requires configuration. In contrast, tracking page hits and errors is generally standardized for all servers.

In general, as shown in FIGS. 1-4, three basic instrumentation structures can be used to capture hit level data. However, it should be appreciated that any other known or later developed method for capturing hit level data can be used to capture and provide the hit level data to the aggregation subsystem 110. As shown in FIGS. 1-4, these three basic instrumentation structures include web server filters 102, log files 104 and in-line instrumentation 106. Each of these instrumentation structures puts different demands on the web server or servers that support the monitored website. Thus, depending on the type of website being monitored and the uses to which the website activity monitoring will be put, different instrumentation structures may be more or less appropriate.

One instrumentation strategy is to place a “filter” in the web server. This web server filter 102 uses hooks in the web server application programming interface (API) to call code whenever a hit is processed. The code that is called extracts information from the data generated by the hit that will be stored in the website activity log, as well as additional information that is available to the web server.

For example, to enable path monitoring, it is necessary to identify the hits generated by a single visitor session. This can be done in a variety of ways, some of which are outlined in the previously incorporated applications. In the Microsoft® Commerce Server™, the Commerce Server™ software automatically generates unique cookies that are carried by the various hits generated during a single visitor's session. The web server filter 102 can also access these cookies as they are generated by the Microsoft® Commerce Server™ to allow the path of hits generated by a single visitor's session to be recognized. In various exemplary embodiments where the web server filter 102 is used in environments other than Microsoft® Commerce Server™, the web server filter 102 is able to generate its own cookie information.

The web server filter 102, by accessing the hit level data as it is generated and processed by the web server, assures that the minimal delay is introduced between each hit being generated and the hit level data being provided to the aggregation subsystem 110. That is, the web server filter 102 receives the hit level data as fast as the web server processes the hits and sends the hit level data directly to the aggregation subsystem 110. It should be appreciated that, conventionally, all popular web server software packages allow for these kinds of web server filters 102 to be included in the web server implementation.

While the web server filter 102 allows for minimal delay between a hit being generated and the hit data being provided to the aggregation subsystem, and does not require any content changes to the monitored web site, the web server filter 102 does require processing time on the web server that supports the monitored website. Thus, the web server filter 102 places additional processing and network bandwidth demands on the web server. Many large websites run server farms where a large number of servers support a single website. Thus, each web server would need to be running one instance of the web server filter 102. Thus, there are no scaling benefits that would reduce these additional processing and network bandwidth demands.

Finally, many websites are supported by servers that are not owned or controlled by the operator of the website. In this case, it may be difficult or impossible to add the physical hardware required to support the aggregation subsystem 110 at the location where the web servers reside.

As discussed in the previously incorporated applications, website activity log files can be parsed to extract the hit level data from the entries in the website activity log. In the previously incorporated applications, however, the website activity logs were not monitored. Rather, they were accessed for later, in-depth analysis. However, near-real-time monitoring of the monitored website can be accomplished by reading the website activity log file 104 as the web server writes the cached hit level data to the website activity log file 104 as new entries. That is, rather than continually writing to the website activity log file 104, most web server software caches each hit into a website activity cache.

Based on how the website has been configured, the website activity cache is flushed and the data stored in the website activity cache is written to the website activity log file 104 on a defined interval or parameter. As long as the interval between flushes of the website activity cache is relatively short, then near-real-time monitoring of the website activity is possible. Depending on the type of website and the type of website activity monitoring that the user wishes to perform, the particular website cache flush interval may need to be as short as a few seconds, or can be as long as an hour or more.

Thus, whether the flush interval for the website activity cash is sufficiently short to allow near-real-time monitoring of the website is implementation-dependent and will effectively depend on whether the flush interval is sufficiently short to allow the desired website activity monitoring and analysis. Of course, if the website activity cache is flushed less frequently than what is desirable in a particular case to allow near-real-time monitoring, the website activity monitoring systems, methods and visualization metaphors according to this analysis can still be used. While the monitoring analysis will not show even near-real-time website activity, the website activity monitoring systems, methods and data visualization metaphors according to this invention still provides quicker feedback than that provided by systems geared towards more in-depth analyses.

It should also be appreciated that using website activity log files 104 to provide the hit level data also means that old website activity log files 104 can be played back as if the data in those website activity log files 104 was being generated in real time. Furthermore, because the old website activity log files 104 represent a fixed amount of data, the time rate of playback of those old website activity log files 104 can be scaled as desired to essentially fast-forward or slow-motion step through the website activity log file 104. In this way, a user can see an entire day of website activity data within only a few minutes, or alternatively can spread out just a few seconds or minutes of website activity log over a much longer period of visualization.

Additionally, because the web server or servers that are supporting the website are already designed to support the system resources and bandwidth required to generate the website activity log file 104, capturing the website activity log data as it is transferred from the website cache to the website log file 104, that is, in effect, capturing the changes to the website activity log files 104, generally does not consume a significant amount of additional processing resources and/or network bandwidth.

Rather than relying on the web server to filter and capture the hit level data as it is generated by hits, or relying on the web server to output the cached website activity log file data, in the third basic instrumentation structure, the web pages of the monitored website actively cause the hit level data to be generated at and/or transmitted to a specific instrumentation server. That is, the web pages of a monitored web site can have a portion of the web page that is associated with a special instrumentation server.

When a visitor hits a web page, each independent element of that web page generates a separate TCP/IP connection to the server storing that piece of data to be displayed on that web page. If the piece of data on the web page resides on the instrumentation server, in response to that piece of information being accessed by the client machine in order to build the web page, a script, an ASP, a Javascript, or any other active control 106 located on the instrumentation server can be executed.

Thus, when the visitor's machine attempts to access that piece of information, the active control 106 on the instrumentation server executes to generate the hit level data for that web page. As a result, the hit level data can be generated without putting any additional burden on the computational or bandwidth resources of the web server and without the latency issues involved in waiting for the web server to flush the web activity cache. Additionally, on the instrumentation server, the active control 106 can record the same information that would have been recorded by the filter 102 on the web server.

However, as should be appreciated, each monitored web page will need to be modified to include the particular piece of information that generates the hit to the instrumentation server. On the other hand, a website that has a large number of pages that do not require monitoring can avoid the large overhead that would be associated with monitoring every web page hit when only a small percentage of those web page hits will ultimately be reflected in the data visualized in the visualization portal 130 or 132.

It should also be appreciated that, by using the instrumentation server and information embedded in the web pages being hit, different pages can activate different scripts or other active controls 106. As such, different hits can generate different types of hit level data with different special information that may be appropriate to each such different page. This allows additional data that would otherwise not be generated using normal website activity log information to be added to the generated hit level data.

This also allows for more streamlined aggregation when web farms are used, as all of the hits that are transmitted to all of the different servers of the web farm for the page information generate hit level data at the same instrumentation server. Thus, rather than having to access data from each of the different servers of the web farm, data can be accessed from a single instrumentation server. Finally, servers that support multiple different websites can use the active controls 106 to transmit the hit level data to different instrumentation servers for each such different website, by using different active control content.

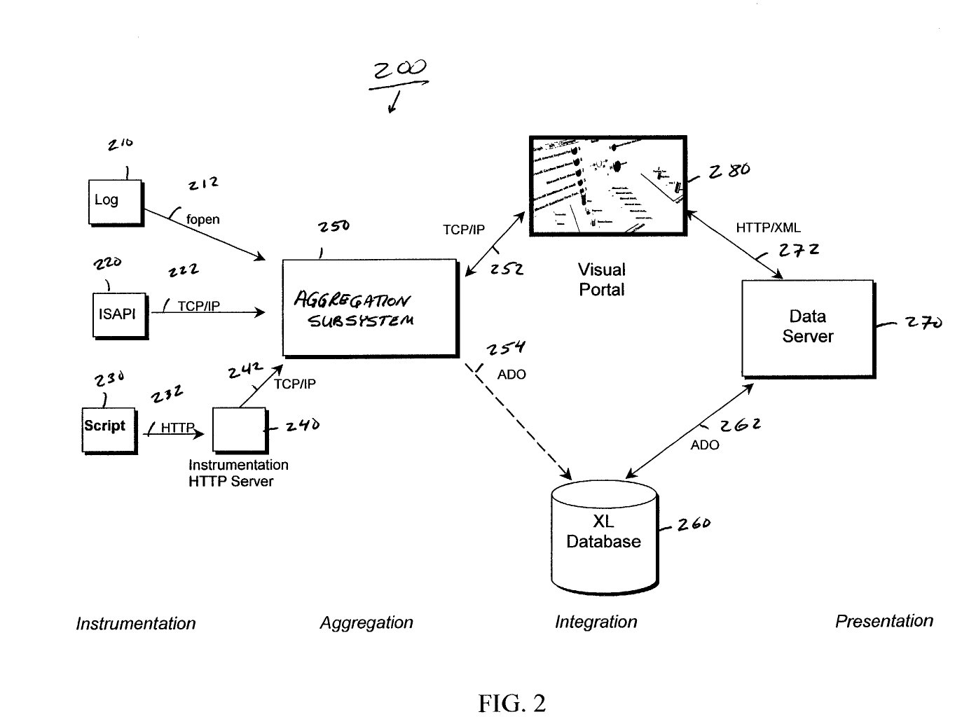

FIGS. 2-4 show first-third exemplary embodiments of a website activity monitoring system 200 and 300 according to this invention. As shown in FIG. 2, in a first exemplary embodiment, the website activity monitoring system 200 includes an aggregation system 250 that can receive the hit level data from a website activity log 210, from a website filter 220 or from an in-line instrumentation system 230 via an instrumentation server 240. In particular, the website activity log 210 is accessed by a file open (Fopen) system call 212 to the website activity log file 210. In contrast, the website activity data filtered by the web server filter 220 is transmitted to the aggregation subsystem 250 over a TCP/IP connection 222. The website activity data generated by the in-line instrumentation system 230 is transmitted to the instrumentation server 240 over an HTTP connection 232. The instrumentation server 240 then transmits the website activity data generated by the in-line instrumentation 230 over a TCP/IP connection 242 to the aggregation subsystem 250.

Once the aggregation subsystem 250 has aggregated the hit level data, as outlined below, the visualization portal 280 pulls the data from the aggregation subsystem 250 over a TCP/IP connection 252. At the same time, if the user wishes to generate a historical record of the visualization data being visualized by the visualization portal 280, the aggregation system 250 can output the same data to a database 260. This data is output over an active data object (ADO) connection 254 if the database 260 is implemented using Microsoft® SQL Server 7. Of course, if another database structure is being used to store this historical data, a particular transmission protocol will be used to implement the connection 254 for that database software.

When the visualization portal 280 is first instantiated, the data server 270 obtains configuration and other instantiation data from the database 260 over a connection 262. The data server 270 then provides this data over an HTTP/XML connection 272 to the visualization portal 280. It should be appreciated that, in the first exemplary embodiment of the website activity monitoring system 200 shown in FIG. 2, the visualization portal 280 is allowed to directly talk with the aggregation subsystem 250. This particular implementation of the website activity monitoring system according to this invention is particularly useful when the aggregation subsystem 250 and the client system running the visualization portal 280 do not have a firewall between the aggregation subsystem 250 and the machine running the visualization portal 280. Because the visualization portal 280 pulls the context data based on the sample interval or tick, the TCP/IP connection 252 is a persistent connection. Thus, if the TCP/IP connection 252 needed to crossover a firewall, such a connection could compromise firewall security.

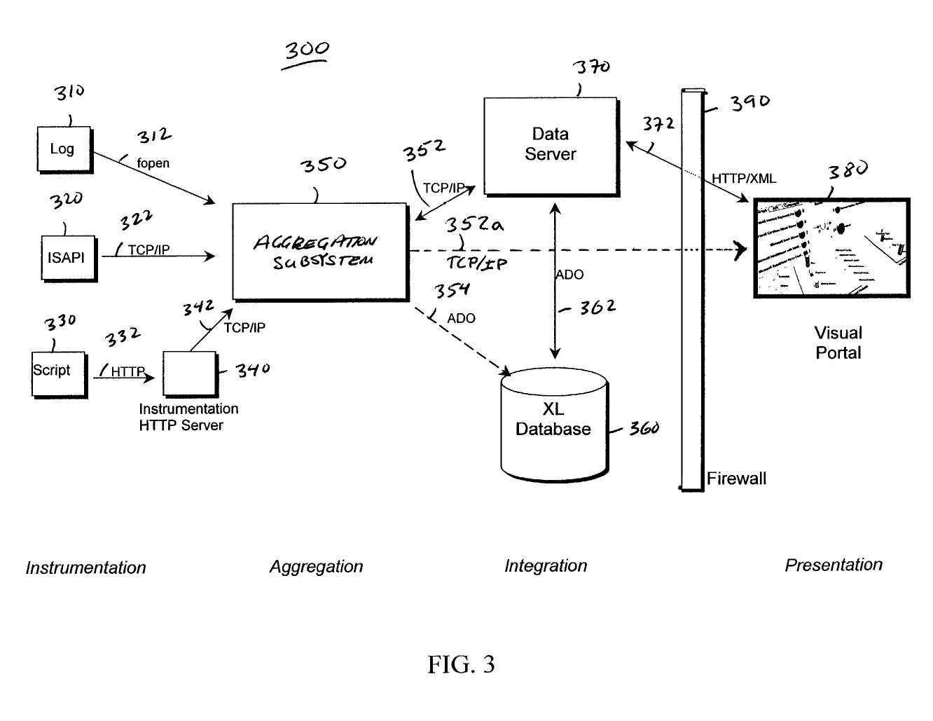

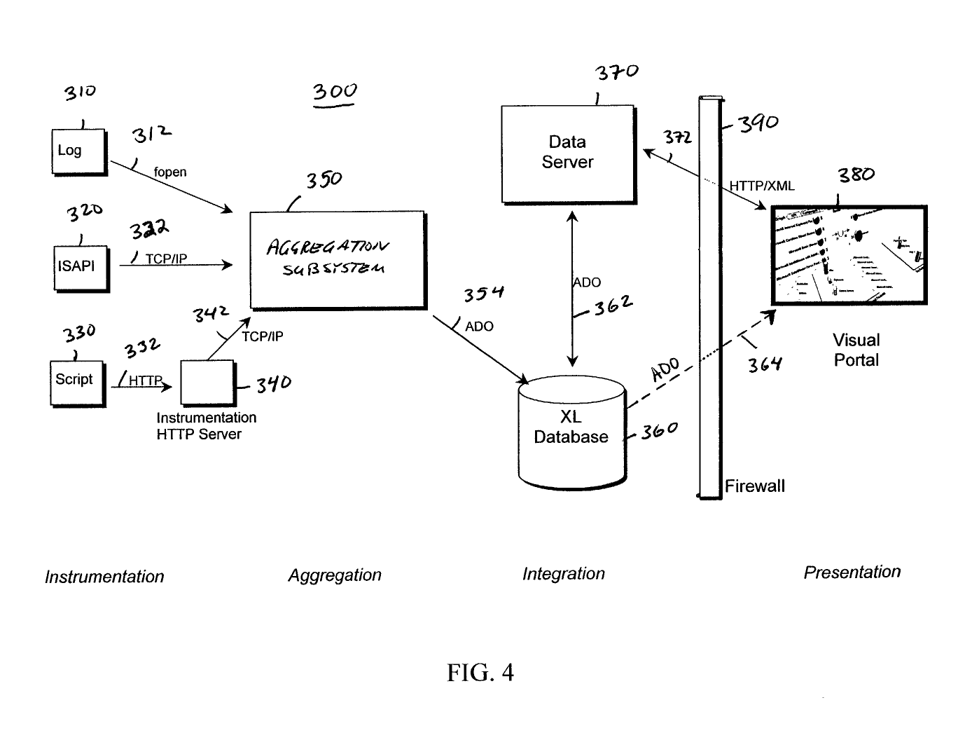

Thus, if a firewall is present between the aggregation subsystem 250 and the machine running the visualization portal 280, one of the second or third exemplary embodiments 300 shown in FIGS. 3 and 4 may be more appropriate. In general, such a firewall between the aggregation subsystem 250 and the machine running the visualization portal 280 will be present if the aggregation subsystem 250 were controlled by an entity different than the machine running the visualization portal 280. Such a situation could occur when the entity owning the server supporting the monitored website is distinct from the entity wishing to monitor the activity on the monitored website, such as a distinct owner of the website.

For example, as outlined above, many companies owning websites do not own the servers on which such websites are supported. Rather, the owners of the website contract with firms who specialize in providing web hosting services. In this case, the aggregation subsystem 250 would most usually be a process executing on one of the machines owned by the web hosting service. In contrast, the user wishing to monitor the website activity would usually be associated with the business owning the website. As such, the machine running the visualization portal would need to pass through the firewall around the web host machine executing the aggregation subsystem 250. This is shown in more detail in FIGS. 3 and 4.

As shown in FIG. 3, in a second exemplary embodiment of the website activity monitoring system 300, one or more of a website activity log 310, a web server filer 320 or an in-line instrument 330 are used to capture hit level data. As indicated above, the hit level data from the website activity log 310 is transferred in view of an “Fopen” system call 312 by the aggregation subsystem 350. In contrast, the data generated by the web server 320 is transferred over a TCP/IP connection 322 to the aggregation subsystem 350. Similarly, the hit level data generated by the in-line instrumentation system 330 is transferred over an HTTP connection 322 to an instrumentation server 340, which retransmits the hit level data over a TCP/IP connection 342 to the aggregation subsystem 350.

However, in contrast to the first exemplary embodiment of the website activity monitoring system 200 shown in FIG. 2, the aggregation subsystem 350 has a direct connection over a TCP/IP connection 352 to the data server 370. At the same time, if the user of the website activity monitoring system 300 wishes to be able to access historical real-time data aggregated by the aggregation subsystem 350, that historical data can also be transmitted over the connection 354 to the database 360.

As outlined above, the data server 370 obtains configuration data from the database 360 over a connection 362. Likewise, if the database 360 stores historical data, such historical data can also be accessed over the connection 362.

The data server 370 is connected to the visualization portal 380 by an HTTP/XML connection 372 that passes through a firewall 390. However, as also shown in FIG. 3, in place of the TCP/IP connection 352 between the aggregation subsystem 350 and the data server 370, a TCP/IP connection 352a between the aggregation subsystem 350 and the visualization portal 380, which passes through the firewall 390, can be used instead. However, as indicated above, this may cause a breach of the firewall 390 that may compromise the security provided by the firewall 390.

FIG. 4 shows a third exemplary embodiment of the website activity monitoring system 300 shown in FIG. 3. As shown in FIG. 4, if the connection 354 is going to be provided between the aggregation subsystem 350 and the database 360, the direct connection 352 between the data server 370 and the aggregation subsystem 350 can be omitted. That is, because the data server 370 already accesses the configuration and historical data stored in the database 360 over the connection 362, the data server 370 can be programmed to access not only the historical data, but the current real-time or near-real-time data which is also being stored in the database 360, over the connection 362. That is, since the real-time data is being stored in the database 360 anyway, that data can be accessed by the data server 370 rather than requiring the aggregation subsystem 350 to both respond to request for data from the data server 370 as well as storing that same data in the database 360. It should be appreciated that, once the data server 370 obtains the real-time or near-real-time data from the database 360, it is transmitted in the same way as in FIG. 3 to the visualization portal 380 over the HTTP/XML connection 372 through the firewall 390.

However, it should also be appreciated that, since the real-time data is stored in the database 360 and accessed by the data server using the connection 362, if the visualization portal 380 is aware that the real-time is being stored in the database 360, the visualization portal 380 can pull the real-time or near-real-time data directly from the database 360 over the optional connection 364 to the database 360 through the firewall 390.

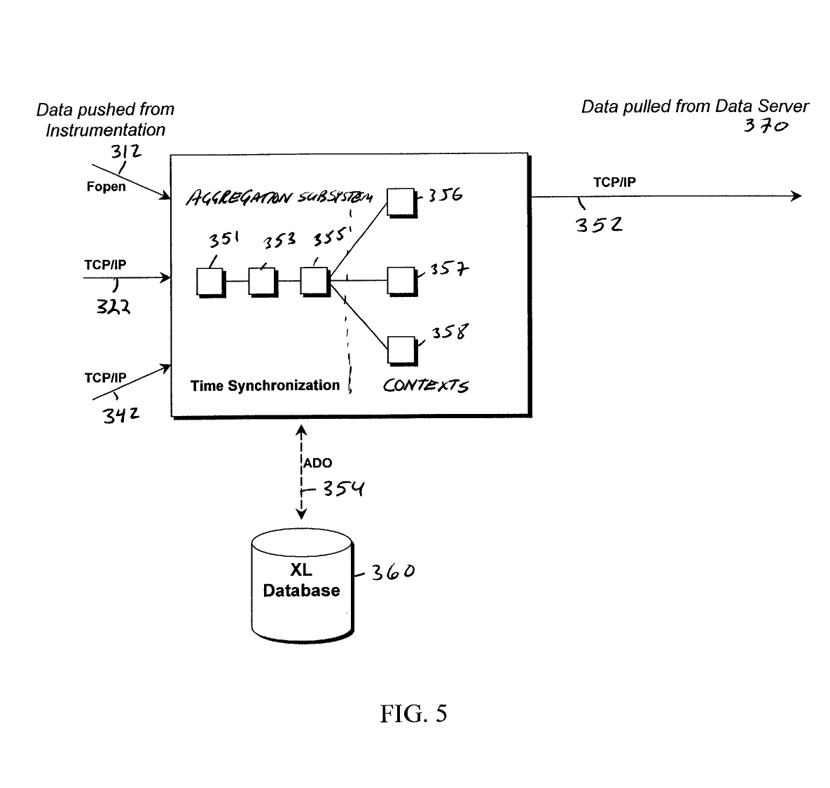

FIG. 5 shows in greater detail one exemplary embodiment of the aggregation subsystem 250 or 350 according to this invention. As shown in FIG. 5, the aggregation subsystem 250 or 350 includes a time synchronization portion comprising ticks 351, 353 and 355 and a context portion comprising one or more contexts 356-358. It should be appreciated that the aggregation subsystem 250 or 350 can be implemented as an NT service when implemented on a Microsoft® Windows NT machine. The aggregation subsystem 250 or 350 maintains one context for each active visualization portal 280 or 380 that is currently pulling data from the aggregation subsystem 250 or 350, either directly or through one or more of the data server 270 or 370 and the database 260 or 360.

Each active context 356-358 contains a definition of the pages, watchlists and/or categories of the website that are to be monitored for that context.

In various exemplary embodiments, for each active context 356-358, new clickstream information is filtered or compared using a watchlist filter against the definition of the pages, watchlists and/or categories for that context. For each active context 356-358, the clickstream information that passes through the watchlist filter for that active context 356-358 is then stored in a tick accumulator for that active context 356-358.

In other exemplary embodiments, a union of the pages, watchlists and categories to be searched for all contexts is used to filter incoming clickstream data. Data that matches this filter is then aggregated for each context if the union of filters indicates that that particular context is tracking that item.

Each tick accumulator is a data structure that gathers counts of hits, sessions, buys and other events for the watchlists and categories monitored by each context. These capturable events include browsing events, marketing events, basket events, commerce events, auction events, inventory events, order processing events, error events, session events, distribution events, support events, and/or scan events, and/or any other known or later developed event that can be initiated by visitor activity within the website. In general, browse events include things like hits, referrals and the like, while marketing events include displaying targeted content, making discounts available to the visitor and the like. Basket events include things like adding things to a shopping basket, removing things from the shopping basket and the like, while commerce events include things like purchasing products and/or services, selling products and/or services and the like, and auction events include things like posting an item or service for bid, bidding on an item or service, and the like.

Inventory events include things like order confirmation notifications, out of stock notifications, restock notifications and the like, while order processing events include things like shipping notifications and the like. Session events include things like a visitor logging in to start a new session, a visitor logging out to end an ongoing session, and the like. Distribution events include things like a visitor subscribing to a service, a visitor unsubscribing from a previously-subscribed-to service, and the like, while email events include things sending a email, receiving an email, and the like. Support events include things like RMAs, ties into a support system to provide customer support, and the like, while scan events include things like tracing a route to find a path to the visitor, and the like.

As indicated above, the counts of hits, sessions, buys and other monitored events, such as the events outlined above, are received from the various instrumentation structures 210-240 or 310-340. When one of the visualization portals 280 or 380 requests information, that visualization portal 280 or 380 receives data stored in the tick accumulator for the context displayed in that visualization portal 280 or 380. Thus, that visualization portal 280 or 380 receives only that data that is relevant for the context displayed in that visualization portal 280 or 380.

The aggregation subsystems 250 and 350 can be connected to one or more web servers. Each web server can be connected to the aggregation subsystem 250 or 350 using any one of the instrumentation structures 210-240 or 310-340 outlined above. As each web server generates hit level data, that hit level data is aggregated for one sample interval or tick. However, it should be appreciated that the ticks from different web servers may not arrive at the same time. Thus, as the ticks from the different web servers are received by the aggregation subsystem 250 or 350, they are sorted by time. The various hits are matched to monitored web pages or events by matching the referring URL, the URI-stem or the URI-query to the monitored web pages. Those hits that match the monitored web pages or events are then combined into one or more contexts using cookies and IP addresses. The visitor sessions are recorded along with any associated ad campaign identifiers.

As the ticks are pushed onto the aggregation subsystem 250 or 350 by the various instrumentation structures 210-240 or 310-340, the hit level data contained with each tick is compared against a first table that indicates which context 356-358, if any, is monitoring hits on each particular page of the website.

The data corresponding to each hit contains information about the page being hit, as well as the referring page, if any. For each hit, the data is searched to find matches of the page information, i.e., the current page hit by the visitor, and of the referral information, i.e., the page from which the current page was reached, with any active context 356-358. As indicated above, not every page of the monitored website is monitored in every active context, and particular pages may not be monitored in any active context. Thus, for any particular context and any particular hit, the context watchlist may match all, some, or none of the data.

When both the page information and the referral information match the watchlist filter for a particular active context 356-358, the information for both the hit page and the referring page are recorded for that particular active context 356-358 in the tick accumulator. When only the referral information matches the watchlist filter for a particular active context 356-358, only the referral information for the referring page is recorded for that particular active context 356-358 in the tick accumulator. The hit information for the hit page is substantially discarded. The only hit information that is retained is whether the hit page was internal or external to the monitored web site.

In contrast, when only the hit page matches the watchlist filter for a particular active context 356-358, only the hit information for the hit page is recorded for that particular active context 356-358 in the tick accumulator. The referral information for the referring page is substantially discarded. The only referral information that is retained is whether the referring page was internal or external to the monitored web site. When neither the page information nor the referral information matches any of the watchlist filters for any of the active contexts 356-358, the page information and the referral information can be entirely discarded.

It should be appreciated that the aggregation subsystem 250 or 350 maintains only enough active history to handle the next tick request for each active context. That is, for each tick, the aggregation subsystem 250 or 350 only maintains stage information for that tick. After each tick is received, the tick data stored for the immediately preceding tick is overwritten with the data for the current tick. Thus, it should be appreciated that, if the aggregation subsystem 250 or 350 wants to maintain a historical record of this hit data, the aggregation subsystem 250 or 350 optionally writes the hit data over the connection 354 to the database 360. Otherwise, as each tick is received, the information from the preceding tick is lost and cannot be regained. Once the aggregation subsystem 250 or 350 has aggregated the data for the current tick into the contexts 356-358, the data server 370 can pull the current data over the TCP/IP connection 352 from each of the contexts 356-358.

It should be appreciated that the aggregation subsystem 250 or 350 can execute on a separate server or can execute on the same web server running one or more of the instrumentation structures 210-240 or 310-340. Thus, if the instrumentation server 240 or 340 is provided to implement the inline instrumentation action system 230 or 330, the aggregation subsystem 250 or 350 can execute on the instrumentation server 240 or 340. Alternatively, if the web server supporting the monitored website is used to implement the website activity filter 220 or 320, the aggregation subsystem 250 or 350 can be implemented on that web server.

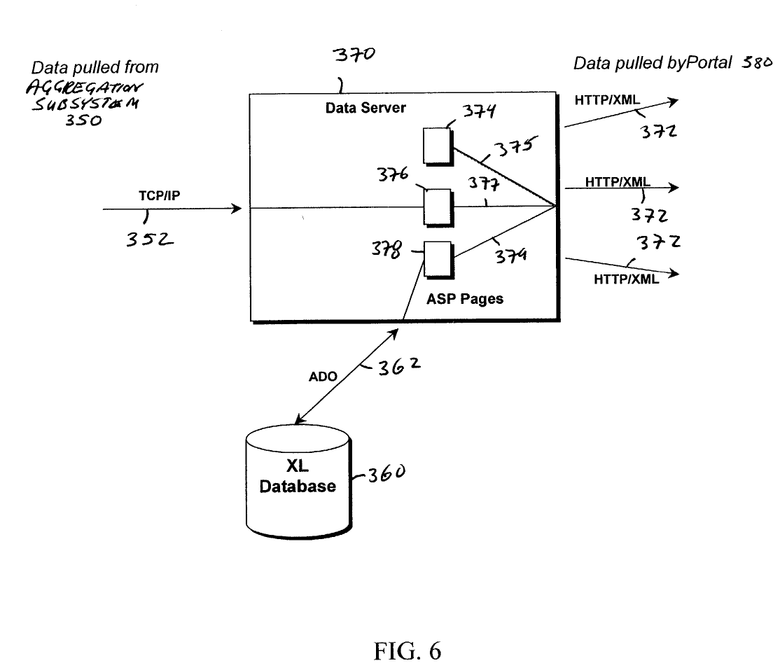

FIG. 6 shows in greater detail one exemplary embodiment of the data server 270 or 370. As shown in FIG. 6, the data server 270 or 370 pulls data from the aggregation subsystem 250 or 350 over the TCP/IP connection 252 or 352 and in turn has data pulled from it over one HTTP/XML connection 272 or 372 for each active data visualization portal 280 or 380. The data server 270 or 370 maintains, for each active visualization portal 280 or 380, one active server page (ASP page). Thus, if there are three active visualization portals 280 or 380, the data server 270 or 370 will maintain three ASP pages 374, 376 and 378, respectively. Thus, many different visualization portals 280 or 380 can access the same aggregation subsystem 250 or 350. Each visualization portal 280 or 380 can have a different set of monitored web pages, watchlists and/or categories organized into a different tree structure and can access the aggregated data based on different time indexes and over different time intervals.

While the real-time data is stored in the corresponding contexts 356-358 in the aggregation subsystem 250 or 350, the historical data, which includes any data prior to the current real-time data, is stored in the ASP pages 374-378 and/or in the database 260 or 360. The data server 270 or 370 integrates the historical and the real-time data using the ASP pages. The data server 270 or 370 pulls the real-time data from the aggregation subsystem 250 or 350 over a transient TCP/IP connection 252 or 352 and uses ActiveX control when communicating with the aggregation subsystem 250 or 350.

The data server 270 or 370 also accesses configuration and layout data for each of the ASP pages 374-378 that is stored in the database 260 or 360 using the connection 262 or 362. In particular, ad campaigns, checkout and other shopping or basket events, and the like are implementation-dependent. Thus, they are configured using the administration manager 122, as outlined above. Thus, when such implementation-dependent events are identified in the event level data aggregated by the aggregation subsystem 250 or 350, they are queried by HTTP queries received from the appropriate visualization portals 280 or 380. The data server 270 or 370 then transmits the visualization data corresponding to the HTTP queries to the visualization portals 280 or 380 over the XML connection 272 or 372.

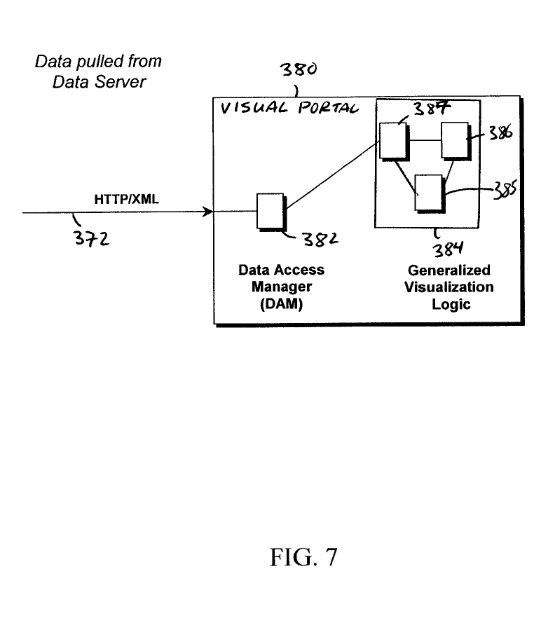

FIG. 7 shows in greater detail one exemplary embodiment of the visualization portals 280 or 380 according to this invention. As shown in FIG. 7, each visualization portal 280 or 380 includes a data access manager 382 and generalized visualization logic 384.

The data access manager 382 manages the access to the data server 270 or 370. The data manager 382 manages this access by using the machine on which the particular visualization portal 280 or 380 is running on as the basis for the data for the data access manager 382. The data access manager 382 is able to determine where the data server 270 or 370 resides, based on the particular active context 356-358 from which that particular visualization portal 280 or 380 was launched.

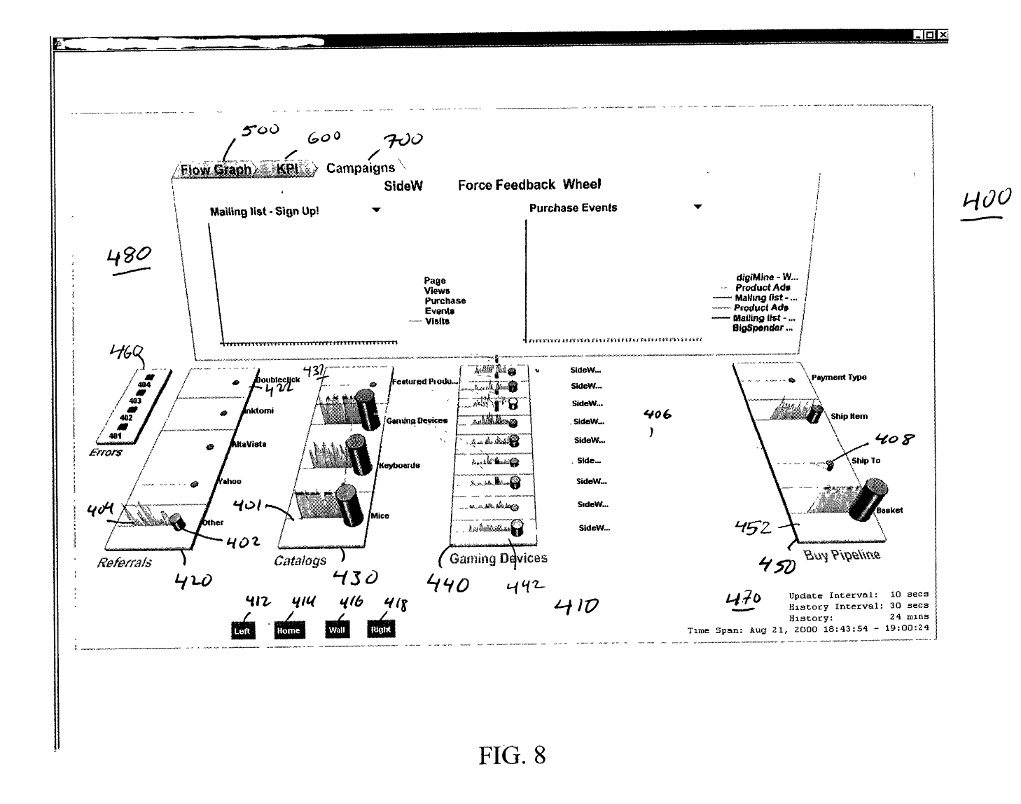

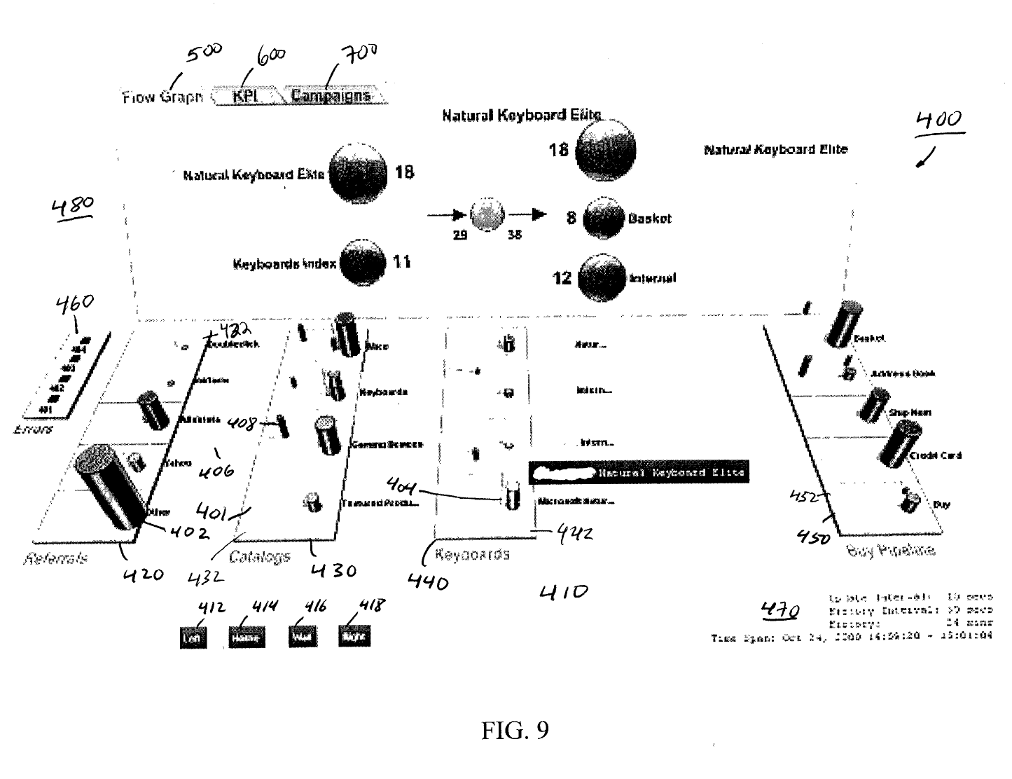

FIGS. 8 and 9 show two instances of a first exemplary embodiment of a data visualization metaphor according to this invention displayable in the visualization portal 380. As shown in FIGS. 8 and 9, the data visualization metaphor 400 includes a floor portion 410, an overlay portion 470 and a back wall portion 480. As shown in FIGS. 8 and 9, the floor portion 410 includes one or more aisles 420, 430 and/or 440, and, if the website sells goods or services, a buy pipeline 450. The floor portion 410 also includes an error bar 460 that indicates the number of errors of each type that the user wishes to monitor.

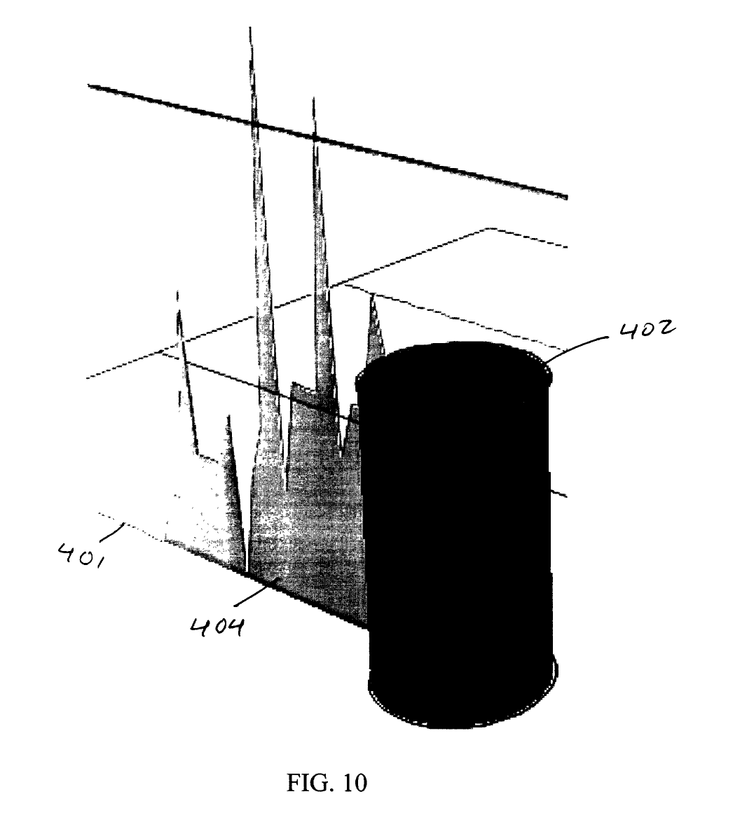

Each of the aisles 420-440 includes one or more portions 422, 432 or 442, respectively, and represents one predefined set, or watchlist or category, of monitored web pages. Each portion 422, 432 or 442 represents one or more monitored web pages, and/or one or more additional sub-watchlists or sub-categories of monitored web pages, of the monitored website. Each portion 422, 432 and 442 includes a timeline 401, a current hit counter 402, and a historical hit count indicator, or tail, 404. This is shown in greater detail in FIG. 10. Each portion 422, 432 or 442, as the real-time data displayed in the visualization metaphor 400 advances one time period, can include an animation comprising a path line 406 and a hit volume indicator 408.

It should be appreciated that each time period represented by the current hit counter 402 and each portion of the tail 404 can correspond to one tick, or can correspond to a number of consecutive ticks. In that case, a number of time periods can include the data for the same tick. That is, for example, each time period can extend over three ticks. In this case, each tick would be included in three time periods, where that tick is a first tick in an earliest one of the three time periods, a middle tick in a middle one of the three time periods, and a last tick in a last one of the three time periods. Aggregating the data for a number of ticks in this way tends to average out rapid fluctuations in the web site activity data.

The path line 406 and the hit volume indicator 408 are used to indicate movement from one monitored web page, watchlist, or category of the website to another monitored web pages, watchlist, or category of the website, or to the shopping cart or basket portion of the buy pipeline 450. Thus, the path indicator 406 and the hit volume indicator 408 indicate movement between monitored portions of the website. The size of the hit volume indicator 408 corresponds to the volume of hits, either in absolute terms or in proportional terms, on one monitored web page watchlist or category that originated from another monitored web page, watchlist or category.

It should be appreciated that the floor portion 410 is a 3-dimensional space. Thus, the point of view onto this 3-dimensional space can be manipulated. This manipulation is performed by clicking on the left button 412, the home button 414, the wall button 416 and/or the right button 418. The left button 412 and the right button 418 allow the point of view onto the floor 410 to be shifted to the left or right, respectively. The home button 414 returns the point of view to the default position. The wall button 416 zooms in and positions the point of view so that the various graphical representations displayed on the wall portion 418 are viewed head-on, rather than at an angle.

It should also be appreciated that the various aisles 420-440 shown in FIGS. 8 and 9 can include any particular set or subset of web pages of the website that the user of the visualization portal 280 or 380 wishes to monitor. The particular organization and the particular web pages, categories, subcategories, watchlists and/or sub-watchlists displayed in each aisle, the label on each aisle, and the particular distinct portions 452 in the buy pipeline 450 are predefined and set forth in layout and configuration data stored in the database 260 or 360. Thus, for example, in FIG. 8, one set of portions 452 are used to form the buy pipeline 450, while in FIG. 9, a different set of portions 452 are used to form the buy pipeline 450.

As shown in both FIGS. 8 and 9, by selecting one of the portions 432 in a first aisle 430 that represents a watchlist or category comprising plurality of web pages, the particular web pages that form that selected and monitored watchlist or category of the website can be displayed in greater detail in the aisle 440. It should further be appreciated, that if the aisle 440 itself represents watchlists or categories of the website encompassing multiple web pages, selecting one of those portions 442 would cause a subsequent aisle to be displayed showing in greater detail the web pages, categories, subcategories, and/or sub-watchlists that form the selected portion 442.

It should also be appreciated that one of the aisles, such as the aisle 442, can be used to display the web pages external to the monitored website that resulted in the monitored website being initially hit. The aisles 442 shown in FIGS. 8 and 9 most clearly show how the user can configure the various aisles 442-444 and the buy pipeline 450.

As shown in FIGS. 8 and 9, this particular user has determined that only four specific external websites from which the hits were received need to be monitored. All other external websites are thus lumped into the “other” portion. It should also be appreciated that, if the user had wished to display more than a predetermined number of web pages within a single aisle 420, 430 or 440, a scroll bar would have been associated with that aisle, to allow different portions 422, 432 or 442 of that aisle 420, 430 or 440 to be displayed in the floor portion 410.

As shown in FIGS. 8 and 9, the wall portion 480 includes a number of tabs 500, 600 and 700. Each of the tabs 500, 600 and 700 allow different types of 2-dimensional graphs to be displayed in the visualization metaphor 400. These tabs 500-700 will be described in greater detail below.

It should be appreciated that, in various exemplary embodiments, the monitored pages within each of the aisles 420, 430, 440 and the buy pipeline 450 can be sorted in a variety of ways. For example, the aisles 420, 430 and 440 can be sorted by the name associated with each portion 422, 432 or 442, or the number of current hits associated with the portions 422, 432 or 442. Similarly, the buy pipeline 450 can be sorted such that the portions 452 are sorted by number of hits, or by the position in the pipeline. It should also be appreciated that the aisles 420, 430 and/or 440 and the buy pipeline 450 can be sorted in either ascending or descending order.

As indicated above, the height or the volume of the current hit counter 402 is proportional to the number of hits recorded for the associated web page or set of web pages, that is, watchlist, category, sub-watchlist or subcategory, during the current tick. The past history tail 404 extending to the left of the current hit counter 402 represents the hit history of this web page, watchlist or category. In various exemplary embodiments, the transparency of a portion of the tail increases logarithmically as the age of that portion of the tail increases, so that older hit counts appear to be less substantial than recent hit counts. The length of the tail 404 and the update period for the current tick for the monitored web pages, watchlists and categories are both definable by the user. Each of the monitored web pages, watchlists and categories uses, in various exemplary embodiments, logarithmic height scaling. In various exemplary embodiments, the current hit counters 402 use proportional scaling to maintain a minimum height to footprint aspect ratio. In various exemplary embodiments, the heights of the current hit counters 402 are normalized as well to a pseudo-logarithmic ladder scaling.

For any monitored web page, watchlist or category, if any purchase events were detected in the current tick for that web page, watchlist or category, then a purchase hit counter (not shown) can be placed on top of the current hit counter 402. In this case, the size of the purchase hit counter is a function of the number of purchases. In general, the same scaling factor will be used for the purchase hit counter as is used for the current hit counter 402. It should be appreciated that both the current hit counter 402 and distinct portions of the tail 404 can be brushed with a cursor to display detailed hit counts and purchase information for either the current tick or for the tick associated with that portion of the tail 404.

The error aisle 460 displays the number and types of errors that are being seen by site visitors for the current tick only. That is, there is no tail associated with the various errors shown in the error aisle 460. The height of the current count indicators associated with each type of error is proportional to the number of errors that are currently being presented to site visitors for each type of error. A wire frame skeleton can be associated with each type of error to show the historical maximum for each type of error. It should be appreciated that, in various exemplary embodiments, each different type of error in the error bar can be brushed to bring up a detailed display that indicates exactly how many errors are happening and where those errors are being encountered within the website.

As shown in FIGS. 8 and 9, the overlay portion 470 includes a number of data items, including an indication of the update interval, an indication of the history interval, an indication of the history span, and an indication of the time of the history span. In particular, the update interval represents the time between data updates for the particular implementation of the visualization portals 280 or 380. This represents how often the visualization portal waits between requests to the aggregation subsystem 250 or 350 for additional information. It also determines the amount of time spent between animations.

The history interval represents the pace at which information is taken from the current activity displays, such as the current hit counter 402, and added as historical data to the tails 404. The history interval also represents the time period used in the flow graphs and the granularity of the key performance indicator and campaign graphs. After each history interval, data is moved from the current view into the historical view and the oldest historical view data is discarded.

The history span represents the amount of time that historical information is retained and displayed in the visualization portal 380. The time span shows the start and end times of the data being presented by the visualization portal. The time span is most useful when viewing historical data, such as, for example, from historical website activity data stored in website activity logs.

Many websites are organized in a very hierarchical manner, with various pages being organized under various categories. In this case, each category is often associated with a single entry or index page. Then, each of the web pages or subcategories organized under that category are accessed by clicking links provided on the category page. This is especially true in catalog and other e-commerce type websites. Experience has shown that, with such hierarchical organizations, users often return to the category page before moving to another link on that category page, rather than moving directly from one subcategory or web page organized under that category page to another web page or subcategory organized under that category page.

Thus, in various exemplary embodiments of the visualization metaphor 400 according to this invention, those aisle portions 422, 432 or 442, which represent categories or other sets of internally-linked web pages, can have two representations within the visualization metaphor 400 depending on whether the subcategories and/or web pages organized within that category are currently being displayed within the visualization metaphor 400, as is shown in FIGS. 8 and 9 for the gaming devices category in FIG. 8 and the keyboards category in FIG. 9.

If the subcategories and web pages are not being displayed, such as for the mice categories in FIGS. 8 and 9, the hit counts and purchase counts for such unexpanded category portions represent the aggregate of all hits and purchase counts for the entire subtree of subcategories and web pages that are organized under that category, including the associated category page. In general, this is done so that the user can monitor activity on the rest of the website while part of the website is expanded.

In contrast, if the category portion is currently expanded, such as the gaming devices category in FIG. 8 and the keyboards category in FIG. 9, then the path indicators 406 and hit volume indicators 408 from the gaming devices and keyboards portions 432 in FIGS. 8 and 9, respectively, indicate hits to the various subcategory portions and web page portions arising from the index page for the gaming devices category and keyboards categories in FIGS. 8 and 9. Early experiments by the inventors showed that without including these index pages in the floor portion 410, visitors navigating within the website appeared to come from nowhere, as most of their visitor sessions pass through such index pages.

As indicated above, the visualization portal 280 or 380 pulls new data from the aggregation subsystem 250 or 350 either directly or through the data server 270 or 370 and/or the database 260 or 360 and updates the floor portion 410, the overlay 470 and the back wall 480. The new hit and visitor session information is first seen in the visualization metaphor 400 in the form of the animated hit volume indicators 408 that jump around from one monitored web page, watchlist, or category to another on the floor portion 410. The size of the hit volume indicators 408 is proportional to the number of site visitors that move from one monitored part of the website to another monitored part of the website. After the animation is complete, the new information replaces the old information, at least in part, as the current values for the purchase and hit indicators 402 for each monitored page, watchlist, or category.

It should be appreciated that the new information may only in part replace the old information, as new hits may be generated on monitored web pages, watchlists, or categories that originated in unmonitored web pages, watchlists, or categories. As such, those hits would not be represented by any animation, unless the one or more aisles 420, 430 and/or 440 included an “other” portion 422, 432 or 442 that represented the other unmonitored web pages or categories. It should also be appreciated that the immediately preceding “current” values for the hit counts and/or purchase are placed into the tail portion 404, while the oldest hit counts and/or purchases fall off the end of the tail 404.

FIG. 10 shows one exemplary embodiment of the current hit indicator 402 and the tail 404 in greater detail. As shown in FIG. 10, in this exemplary embodiment, the current hit indicator 402 is a three-dimensional object, while the tail 404 is a two-dimensional object. However, it should be appreciated that, in other exemplary embodiments, the current hit indicator 402 could be a two-dimensional object. Similarly, it should be appreciated that, in still other exemplary embodiments, the tail 404 could be a three-dimensional object.

Similarly, it should be appreciated that, when both the current hit indicator 402 and the tail 404 are two-dimensional objects, the floor portion 410 could be a two-dimensional window. In this case, the aisles 420-440 would simply be columns within that two-dimensional window.

As shown in FIG. 10, one of the dimensions of the three-dimensional current hit indicator 402, in this case, its height, is used to represent the amount of visitor activity during the current time period. However, it should be appreciated that other dimensions, such as radius, depth, width or the like, or other characteristics, such as visual appearance, like shading, color, hue, brightness, contrast, color depth, or the like, or any other appropriate characteristic, could be used to represent the amount of visitor activity during the current time period. For example, as visitor activity increases, the color of the current hit indicator could change from a light, pale color, such as a light pink, to a deep, saturated color, such as a fully saturated red, or from a cool color, such as violet, to a warm color, such as red.

Similarly, as shown in FIG. 10, one of the dimensions of each portion of the two-dimensional tail 404, in this case, its height, is used to represent the amount of visitor activity that occurred during the time period corresponding to that portion of the tail 404, while an appearance, in this case, transparency, of that portion of the tail 404 is used to represent the age of that portion of the tail 404. However, it should be appreciated that other dimensions, such as radius, depth, width or the like, or other characteristics, such as visual appearance, like shading, color, hue, brightness, contrast, color depth, or the like, or any other appropriate characteristic, could be used to represent the amount of visitor activity that occurred during the time period corresponding to that portion of the tail 404. For example, a depth of each portion of a three-dimensional tail 404 could decrease as that portion of the tail 404 ages.

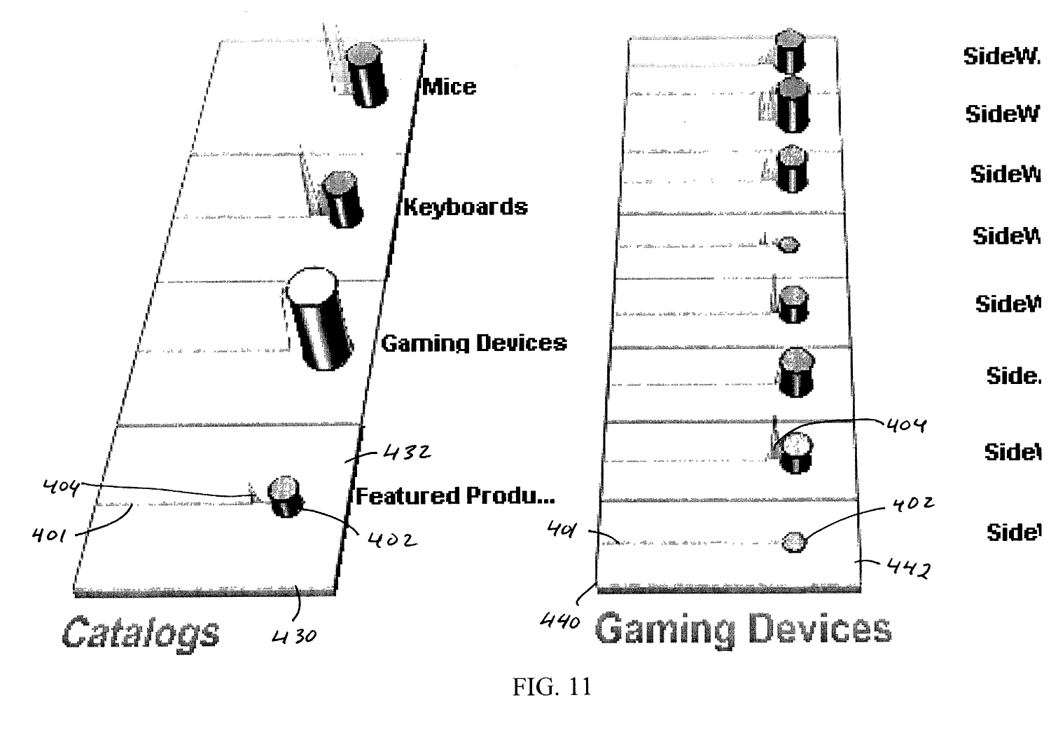

FIG. 11 shows the aisles 430 and 440 of FIG. 8 in greater detail. In particular, in FIG. 11, the aisles have been resorted into descending alphabetical order.

Additionally, the data from a historical website activity log can be displayed along with the current real-time or near-real-time data, however gathered. This allows comparisons of the real-time and/or near-real-time data to the historical data recorded in the website activity logs to be performed. For example, in FIGS. 8 and 9, as the current real time website activity data is displayed on the floor 410, some other set of stored data can also be accessed and displayed on the floor 410. For example, this other data could be the same context for a different, previous time period, such as the previous day, the same day the previous week, month or year, or the like. By displaying both the real-time data and the stored data, the real-time data can be visually compare it to the stored data.

In one exemplary embodiment, the stored data for a particular context can be used to generate corresponding watchlist indicators, such as the current hit value indicators 402 and the tails 404, adjacent to, next to, below or above the real-time data. In other exemplary embodiments, the stored data for a particular context can be combined with the real-time data, so that only the difference between the stored data and the real-time data is displayed. For example, the current hit value indicators 402 and the tails 404 displayed on the floor 410 could have a first visual appearance, such as the color red, when the real-time data is less than the corresponding stored data, and have a second visual appearance, such as the color green, when the real-time data is more than the corresponding stored data.

It should also be appreciated that two sets of stored data, rather than one set of stored data and one set of real-time data can be compared using this technique. Similarly, three or more sets of data, whether all stored data or using one real-time set of data, can be displayed as well. It should also be appreciated that the ‘other’ data could be processed data, like an average over time, rather than raw stored real-time data from a previous time period.

In various exemplary embodiments, it may be desirable to quickly identify which web pages, watchlists and/or categories are performing better than others. In the context of retail-oriented sites, purchases by visitors are usually a good metric for performance. Accordingly, in various exemplary embodiments, a performance indicator is added to the current hit value indicator 402 that shows how many performance events, such as purchases by visitors, have occurred over the time span represented on the floor 410. Such performance indicators can be, for example, rings around the cylindrically-shaped current hit value indicators 402.

As discussed above, traffic flowing through web pages that are not associated with any watchlist or category shown on the floor 410 is not shown in the animation provided by the path lines 406 and hit volume indicators 408. The hits are counted so the current hit value indicators 402 are the right height, but no animation will go to those current hit value indicators 402. The visitor session information could be used to determine where the animation should come from in those cases.

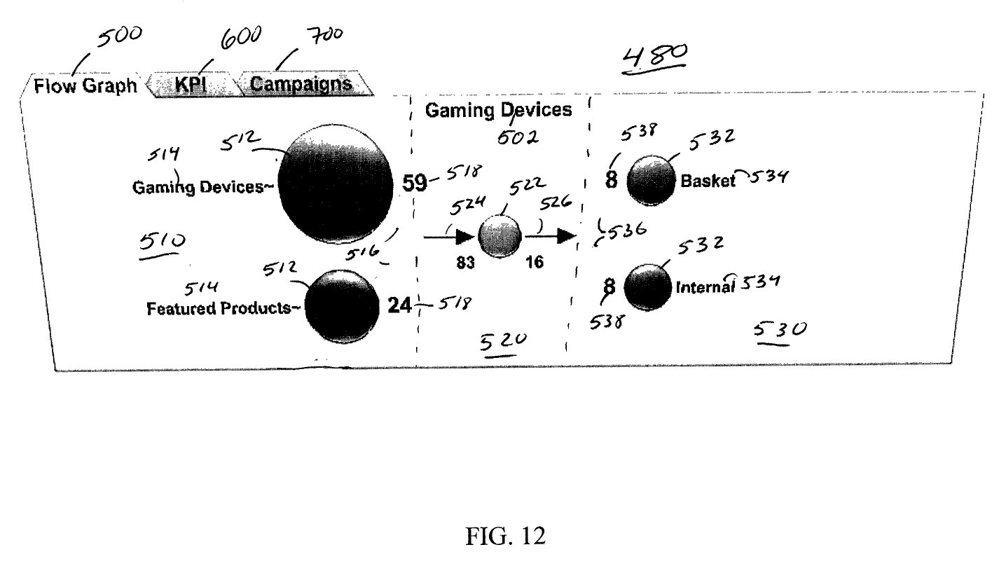

FIGS. 12-18 show various exemplary embodiments of the back wall 480. The back wall 480 of the visualization metaphor 400 shows additional information about some selected web page, watchlist, or category of the website that has been selected by the user. Generally, the selected page, watchlist, or category is one of the monitored web pages, watchlists, or categories displayed on the floor 410 of the visualization metaphor 400. The user may select any one of the tabs 500, 600 or 700 to determine which additional information is to be displayed.

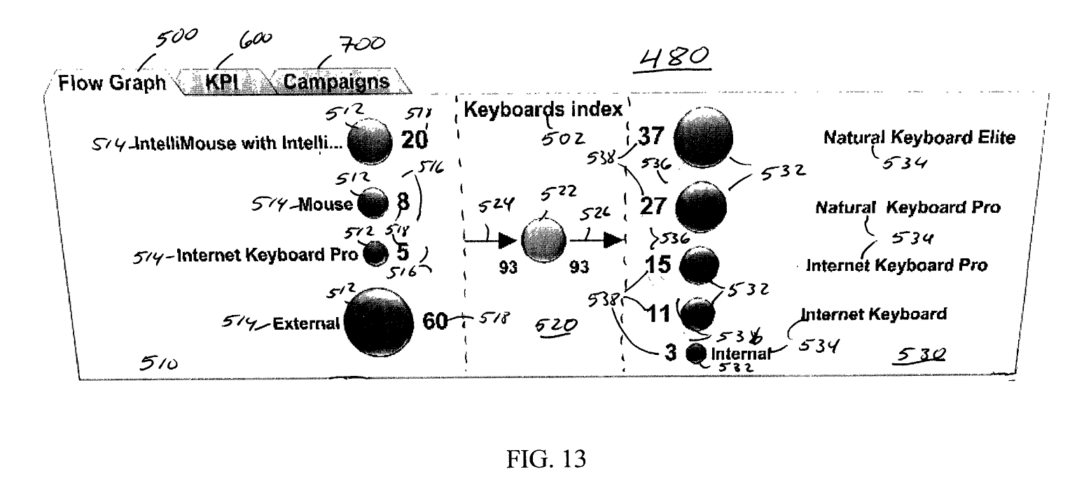

FIGS. 12 and 13 show two instances of one exemplary embodiment of a flow graph tab 500 according to this invention. As shown in FIGS. 12 and 13, the flow graph on the flow graph tab 500 shows a breakdown of the traffic through a particular selected, or focus, web page, watchlist, or category. The number of hits to and from the focus web page, watchlist, or category are summed up, then broken down by source and destination, respectively. The values on the flow graph tab 500 represent the total number of hits seen during the entire history interval, including both the current value and the entire history tail, recorded by the visualization metaphor 400.

In particular, FIG. 12 represents the gaming devices category of FIG. 8, while FIG. 13 represents the keyboard category of FIG. 9. As shown in FIGS. 12 and 13, the flow graph of the flow graph tab 500 includes a referring portion 510, a focus portion 520 and a destination portion 530, as well as a title 502 that indicates the currently selected page, watchlist, or category of the monitored website. The referring portion 510 includes one or more referring web page, watchlist, or category markers 512. Each marker 512 includes a label 514 that indicates the website page, watchlist, or category corresponding to that marker 512. One link 516 extends from each marker 512 and links that marker 512 to a referring total indicator 524 of the focus portion 520. Finally, each marker 512 has a numerical value 518 associated with it to indicate the number of hits from the referring web page, watch list or category represented by this marker 512 to the web page or pages that are represented by the focus portion 520. This number of hits is also represented by the size of the marker 512.

The focus portion 520 includes a focus marker 522, the referring total indicator 524 and a destination indicator 526. The referring total indicator 524 indicates the total number of hits that arrived within the current history interval from the web pages, watchlists, or categories displayed in the referring portion 510. The destination indicator 526 indicates the number of hits to other web pages outside of the gaming devices category that originated from one of the web pages or subcategories within the gaming devices category within the current history interval.

The destination portion 530 indicates the various web pages, watchlists, and/or categories having hits within the current history interval that originated from the gaming devices index page or one of the subcategories and/or web pages within the gaming devices category. Each such web page, watchlist, or category has a marker 532 with an associated label 534, a link 536 and a numerical value 538, which indicates the number of hits from the web page or pages represented by the focus portion 520 to each particular web page, category or watchlist represented by a particular marker 532.

It should be appreciated that the “internal” marker 532 shown in FIG. 12 and the “external” marker 512 shown in FIG. 13 represent hits to or from web pages or categories that are not being actively monitored. For example, the external marker represents hits from sites external to the site being monitored. In particular, hits from the external marker to the focus marker 522 indicate visitors that are using the focus index or web page as the entry page to the monitored website. The internal marker 532 represents all pages that are internal to the monitored website but that are not included in any monitored category or web page.

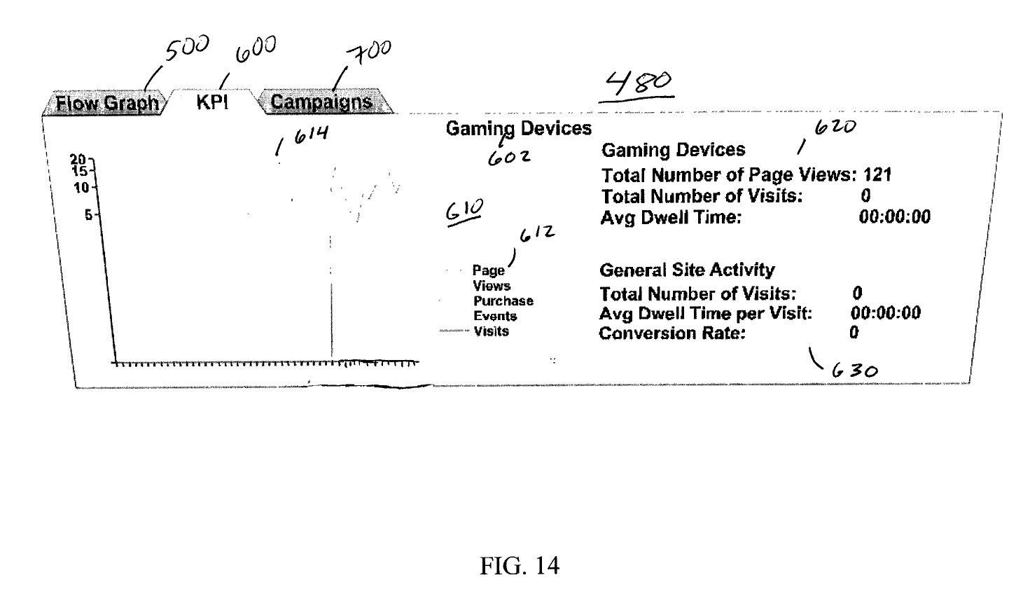

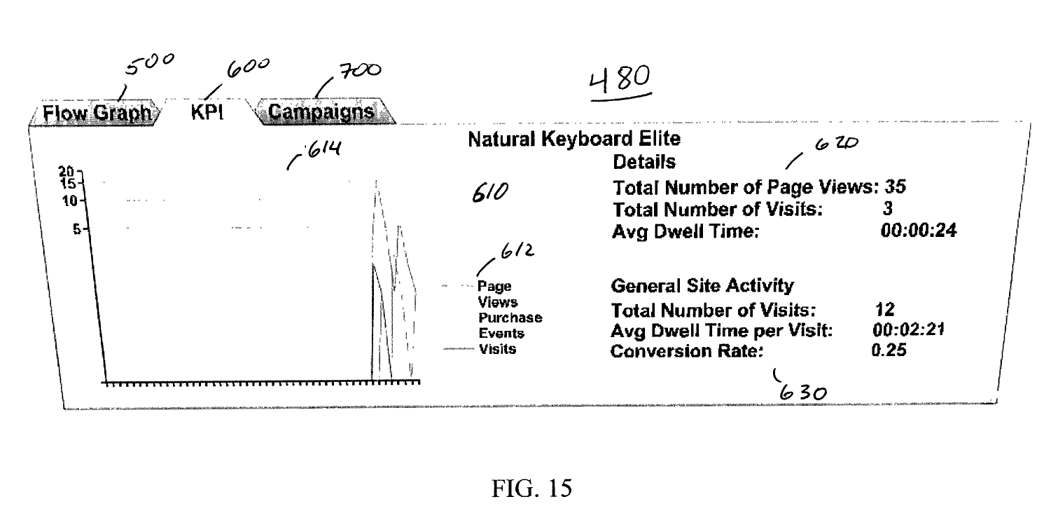

The KPI tab 600 shown in FIGS. 14 and 15 displays “key performance indicators” for the monitored website. For a selected web page, watchlist, or category, a line chart within the KPI tab 600 shows hits, purchase events, visits and the like over time. It should be appreciated that visits are defined as a number of unique visitor sessions that have viewed a given page, watchlist, or category.

It should be appreciated that FIG. 14 corresponds to FIG. 8, while FIG. 15 corresponds to FIG. 9. As shown in FIGS. 14 and 15, the key performance indicator tab 600 includes a title portion 602 that indicates the selected webpage, watchlist, or category, a graph portion 610, a selected web page, watchlist, or category details portion 620 and a general site activity details portion 630. The graph portion 610 includes one or more lines, as indicated by the legend portion 612, that are graphed in a graph portion 614. The selected focus details portion 620 shows details specific to the selected web page, watchlist, or category.

The details portion 620 shows the numerical value for the total number of hits over the history interval tracked by the visualization metaphor 400 for the selected web page, watchlist, or category, the number of distinct visits to the selected web page, watchlist, or category, and the average amount of time that a visitor dwells within the web page or category. The general activity site details portion 630 is shown to give a sense of context for the value shown in the details portion 620. The total number of visits and the average dwell time calculated over the history interval spanned by the visualization metaphor 400. The conversion rate is defined as the total number of sessions that have specific events associated with them divided by the total number of sessions over the history interval. For e-commerce sites, the specific events are usually purchase events.

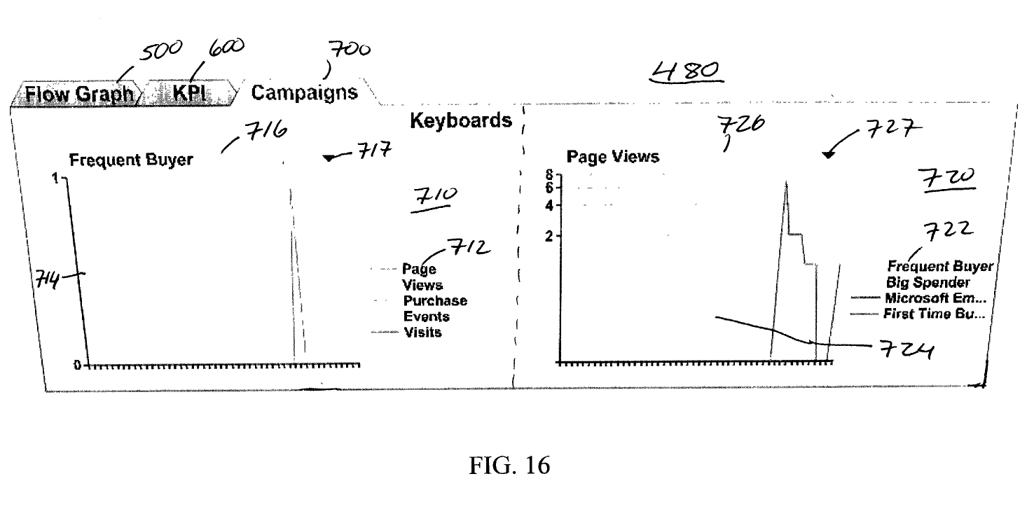

FIG. 16 shows a campaign tab 700 for the visualization metaphor 400 shown in FIG. 9. The campaign tab 700 generally displays advertising campaign data. Advertising campaigns, or “promotions” as used in the incorporated 761, 737 and 557 applications, are common to many marketing strategies, though the advertising campaign may be referred to by some other name. However, it should be appreciated that the Microsoft® Commerce Server™ uses a specific “campaign” data structure to store and organized advertising campaign information. Because of this specific “campaign” data structure, campaign definitions can be easily extracted from the Commerce Server™ operational database and used to populate one of the drop down menus of the campaign tab 700, which are discussed below.

As shown in FIG. 16, the campaign tab 700 includes a campaigns portion 710 and an events portion 720. The campaign portions 710 displays the events identified in the legend portion 712 against a particular selected campaign as indicated by the campaign title portion 716. The data is then graphed in the graphed portion 714 for the selected campaign against the various events identified in the legend portion 712. Different campaigns can be selected using the drop down menu selector 717.

In contrast, the events portion 720 graphs various campaigns against a selected event. Thus, the legend portion 722 indicates the various campaigns against which a selected event will be graphed. In particular, the campaigns incorporated into the legend portion 722 are the same campaigns that were accessed using the drop down menu 717. In the events portion 720, the values of a selected event, as indicated by the title bar 726, are graphed against the various campaigns, as indicated in the legend portion 722, in the graph portion 724. The different events can be selected using the drop down menu portion 727. In particular, the various events that can be selected using the drop down menu portion 727 correspond to the events displayed in the legends portion 712 of the campaign portion 710.

In order to provide useful information to the customer, the website activity monitoring systems methods and visualization metaphors according to this invention require some information that is not available from the clickstream in order to correlate with clickstream data. This information comes from the infrastructure of the monitored website. In general, there are two different approaches for retrieving this data and processing clickstream data against it. The first approach is based on the services provided by some web server software packages, such as the Microsoft® Commerce Server™ web service software. When the website is hosted using such service-rich web server software, the website activity monitoring systems and methods and visualization metaphors according to this invention can use such services as the primary source of the integration data. In general, for versions of the website activity monitoring systems, methods and visualization metaphors that are specifically designed to be used with such service-rich service software, the visualization portal 280 or 380 should generally always be started from a web page that is hosted on that server. Thus, that server must be accessible to the visualization portal 280 or 380. That server also provides built-in access control.

When the visualization portal 280 or 380 is first instantiated, the visualization portal 280 or 380 checks to see if an integration data source has been explicitly provided. If so, that source is then used. Otherwise, the visualization portal 280 or 380 tries to find the web server that is hosting the HTML page from which the ActiveX control of the visualization portal 280 or 380 has been launched. The visualization portal does this by querying the OLE container of the visualization portal 280 or 380 to find the application that is hosting it. Depending on which browser is hosting the visualization portal 280 or 380, the visualization portal queries the web browser for the HTTP server that launched the page that the visualization portal inhabits. For example, if the web server is the Microsoft® Commerce Server™, then the hosting web browser will be the Microsot® Internet Explorer®. The visualization portal 280 or 380 thus queries the Internet Explorer® for that HTTP server.

Once a server is established, then the visualization portal 280 or 380 hits one or more ASP pages on that server to retrieve integration data. ASP was used as the integration mechanism on the server because it is a scripting environment, so custom installations and advanced users can alter the scripts if the scripts need to be updated. The ASP pages are hit via simple HTTP queries from the visualization portal 380. The query replies are sent back as XML. XML was used because it is easily parsed and verified. Additionally, XML can represent scalar, vector and tree-structured data with equal ease. Thus, it should be appreciated that any other known or later developed mechanism that provides similar features can be used in place of the ASP pages, the HTTP queries and/or the XML replies.

Upon startup, the visualization portal 280 or 380 requests one or more pieces of information to help configure its behavior. These pieces of information include one or more of a session cookie criterion, an aggregation subsystem identity, an agent host list, a referrals list, a buy pipeline, a campaigns list, a catalog list, or any other known or later-developed configuration information that would be appropriately requested by the visualization portal 280 or 380. In particular, the session cookie criterion is a user-defined, delimited list of tokens that will be sent to the aggregation subsystem 250 or 350 on startup. This list is used to identify visitor sessions when the services-rich web server automatically adds session cookies, such as the cookies generated by the Microsoft® Commerce Server™. The aggregation subsystem identity is a user-defined string and number that identifies the host name and port number of the click stream aggregation subsystem 250 or 350. The aggregation subsystem identify can be specified here so that it resides in a central location. Thus, if the aggregation subsystem 250 or 350 is moved, the hosting web server can easily find it again without having to reinstall the software.

The agent host list is a user-defined, delimited list of host names that identify the web servers used with web server software that generate log files that do not contain sufficient information to identify the web server or servers identified with the log file. The agent host list is thus used when the aggregation system 250 or 350 processes log files so that the aggregation subsystem 250 or 350 can determine which hits are internal or external to the monitor to website.

The referrals list is a set of user-defined lists that define the external referrals that the user wishes to track as visitors enter the monitored website. Any external referrals that are not in the referral list are placed into an “other” referral category.

The buy pipeline list is a set of user-defined lists that define the set of pages that a visitor traverses when the visitor purchases something from the monitored website.

The campaigns list identifies advertising campaigns stored in an operational database of a services-rich web server, such as the Microsoft® Commerce Server™ to retrieve detailed information about currently-defined campaigns. These campaigns will be used to expand upon campaign information obtainable from the clickstream data.

The catalog lists identify product catalog information provided by a services-rich web server, such as the Microsoft® Commerce Server™. The private catalog is traversed via conversing with ActiveX objects on the sever that represent the operational database logical schema. If more than one catalog is present in the database and the user has not singled one catalog as the primary catalog of interest, then all of the catalogs are traversed. In general, catalogs are defined as multiple-level trees. The results are added to the current lists of monitored web pages, watchlists, and categories inside the visualization metaphor 400 implemented in the visualization portal 280 or 380 and transmitted to the aggregation subsystem 250 or 350 against which incoming web page hits should be filtered.

In structured environments, such as the Microsoft® Commerce Server™, detailed information about customer purchases is available at the time of a purchase. A purchase event is recognized as a hit on a certain web page. At that point, the purchasing sessions associated structures can have their buy counts incremented. The campaign information is extracted from the purchase hit, and the associated campaign, if any, is updated. Finally the buy string is extracted from the purchase hit and is passed to an ASP end page on the web server to determine what products were purchased. The string is used to index into some operational database tables that are kept up to date with purchase information by the web server. As a result, it is possible to determine what products were purchased and how much money was spent. This information is used to update buy totals in the visualization metaphor 400, for particular product pages, as well as for particular visitor sessions.

Configuration information is associated with a user ID that identifies the user of the website activity monitoring systems according to this invention. This user ID may be an unverified user-supplied string or, depending on the particulars of the installation, may be a log-in ID that is enforced by the operating system. This allows all queries to carry the user ID along with them, so that distinct different configuration and integration information can be stored for each distinct user of the system.

In order to facilitate operation in extranet configurations, all data access, including configuration, integration and clickstream access, is initiated by the visualization portal 280 or 380 using HTTP requests. The data requests are handled by a data server 270 or 370 that generates XML-based replies to those requests. If the visualization portal 280 or 380 has been explicitly pointed towards a specific web server, than that web server is used. If no specific web server has been specified, then the visualization portal 280 or 380 attempts to find the web server that is hosting the HTML page that the ActiveX control of the visualization portal 280 or 380 has been launched from. As indicated above, this is performed by querying the OLE container for the visualization portal 280 or 380 to find the web browser that is hosting the visualization portal 280 or 380. This HTTP server will then be used as the data server 270 or 370 by the visualization portal 280 or 380.

Once a server is found, then the visualization portal 280 or 380 hits ASP pages on the web server to retrieve data. Using ASP provides an integration point that is accessible via industry-standard transport with well-understood security mechanisms. The integration functions are also customizable at the end-user site. The integration pages are hit via simple HTTP queries from the visualization portal 280 or 380.

The query replies are sent back as XML. In particular, XML was used because it is easily parsed and verified and it can represent the scalar, vector and tree-structure data with equal ease. Thus, it should be appreciated that any other known or later developed mechanism that provides similar features can be used in place of the ASP pages, the HTTP queries and/or the XML replies.

Upon startup, the visualization portal 280 or 380 will query the web server for various pieces of information. In general, with less structured web server environments, the layout of the visualization metaphor 400 can be more flexible than with more structured web servers. This allows the visualization metaphor 400 to be mapped onto a wider variety of websites. In general, only the referral aisle 420 will be predefined. In this case, the referral aisle 420 will be formed of user-defined web pages and web pages generated by the “campaign definition” query, as outlined below.

In general, the visualization portal 280 or 380 will generate queries to the server regarding one or more of the aisle definition, the aisle layout, the campaign definition, the commerce type page templates, and/or custom visitor type page templates, among others. In particular, the aisle definition is a set of web page monitor entries that define each aisle in the visualization metaphor 400. The aisles are defined as multi-level trees. If a tree has a depth greater than one, then it will be expandable as outlined above. Otherwise, it is a static aisle. For each aisle, the monitored web pages, watchlists and/or categories within it are defined, as well as the label for display purposes. The aisle layout query is used to assign locations on the floor 410 of the visualization metaphor 400 for the aisles.

The campaign definition query is used to identify the set of campaigns and promotions currently defined in the database 260 or 360. This information will be used to identify campaigns and promotions in the clickstream data.

The converse type page template query is used to access templates that are used to identify certain types of visitor activity within the clickstream data. These templates are used for example, to generate “checkout complete” commerce types, such as buyers, or to create lists of monitored web pages, watchlists and/or categories that will be associated with purchase activity for a visitor session. The custom visitor type page templates query is used to access templates that are used to identify user-defined and visitor activity. These templates will be used to create lists of monitored web pages that will be associated with the user-defined activities.

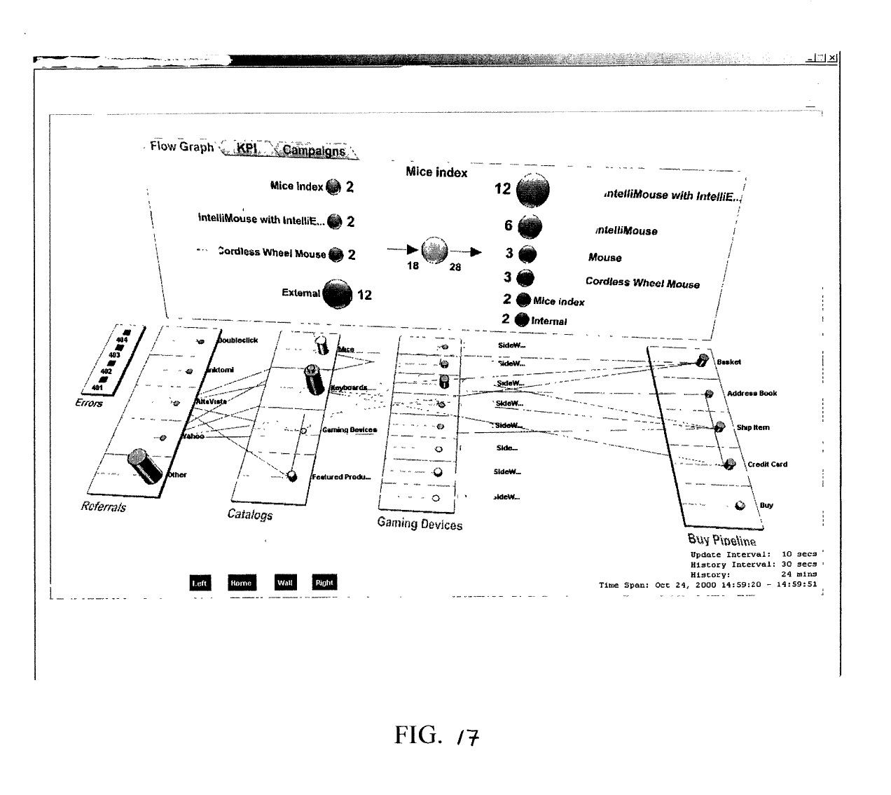

FIG. 17 shows a second exemplary embodiment of the visualization metaphor 400 according to this invention. As shown in FIG. 17, session lines 409 can indicate the paths taken within visitor sessions through the website. In particular, the visitor session lines 409 can be filtered to display only those visitor session lines that go through a particular set of lists of monitored web pages, watchlists or categories. In particular, the visitor session lines 409 can be filtered in an “and” mode, so that only those visitor sessions that go through all of the specified monitored web pages, watchlists or categories are displayed. Alternatively, the visitor session lines can be filtered in an “or” mode, such that the displayed sessions are those that go through any one of the monitored web pages, watchlists or categories. Finally, the sense of the filter can be reversed so that only those visitor sessions that do not go through one or all of the selected lists of monitored web pages, watchlists or categories are shown.

It should also be appreciated that, although it is not shown, additional tabs can be added to the back wall 480. For example, a tab that shows overall site performance from a technical point of view, instead of from a business point of view, can be added to the back wall 480. This tab would show statistics for each physical web server, such as for example, hits per second, processor utilization, errors reported, and the like.

Similarly, the floor portion 410 can include additional controls beyond the left, right, home, and back wall buttons 412-418 discussed above. For example, the floor portion 410 could have a set of controls that allow the user to move forward or backward in time or to speed up or slow down the replay speed. This would be especially useful when visualizing historical data such as from a log file or from the database 360.

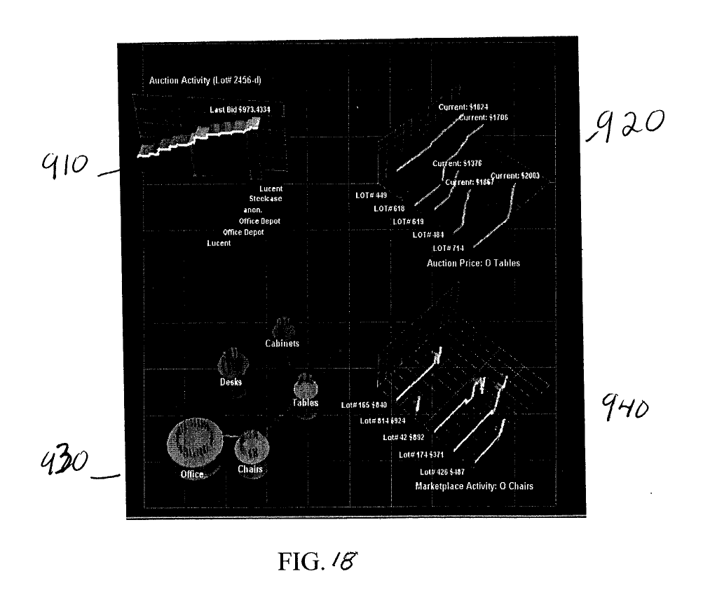

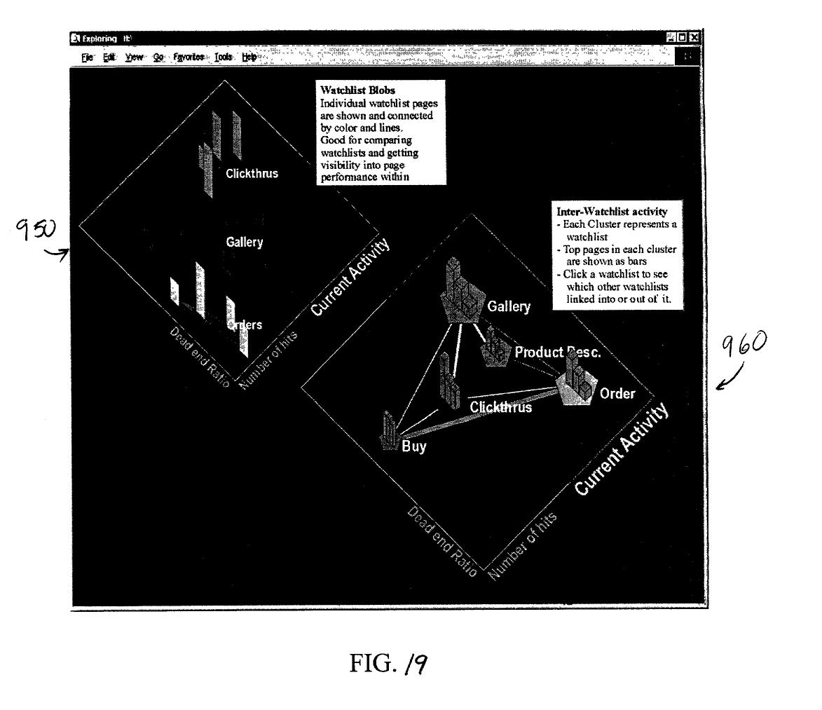

FIGS. 18 and 19 illustrate a number of alternative 3-dimensional objects usable to visualize the real-time or near-real-time data of the monitored website.

Each of the website activity monitoring systems 100-300 is, in various exemplary embodiments, implemented on a programmed general purpose computer. However, each of the website activity monitoring systems 100-300 can also be implemented on a special purpose computer, a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like. In general, any device, capable of implementing a finite state machine that is in turn capable of implementing the operation of the website activity monitoring systems 100, 200 or-300, can be used to implement the website activity monitoring systems 100, 200 or-300.

Moreover, each of the website activity monitoring systems 100-300 can be implemented as software executing on a programmed general purpose computer, a special purpose computer, a microprocessor or the like. In this case, each of the website activity monitoring systems 100-300 can be implemented as one or more routines, as one or more resources or services residing on a server, or the like. Each of the website activity monitoring systems 100-300 can also be implemented by physically incorporating it into a software and/or hardware system.

Each of the various connections shown in FIGS. 1-7 can be any known or later developed device or system for connecting the corresponding elements shown in FIGS. 1-7, including a direct cable connection, a connection over a wide area network or a local area network, a connection over an intranet, a connection over the Internet, or a connection over any other distributed processing network or system. In general, each of these connections can be any known or later developed connection system or structure usable to connect the corresponding elements shown in FIGS. 1-7.

It should be understood that each of the structures shown in FIGS. 1-7 can be implemented as portions of a suitably programmed general purpose computer. Alternatively, each of the structures shown in FIGS. 1-7 can be implemented as physically distinct hardware circuits within an ASIC, or using a FPGA, a PDL, a PLA or a PAL, or using discrete logic elements or discrete circuit elements. The particular form each of the structures shown in FIGS. 1-7 will take is a design choice and will be obvious and predicable to those skilled in the art.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A system for visualizing activity on a node of a distributed network, comprising:
an activity monitoring system usable to capture visitor activity relative to the node of the distributed network; and
an activity visualization system that generates a graphical representation based on the captured visitor activity, the graphical representation comprising:
a entry portion, the entry portion including at least one entry point segment, each entry point segment representing a portion of the node of the distributed network used by visitors to enter the node of the distributed network and including a representation of visitor activity relative to that portion of the node of the distributed network; and
a monitor portion, the monitor portion including at least one node section segment, each node section segment representing a portion of the node of the distributed network and including a representation of visitor activity relative to that portion of the node of the distributed network.

2. The system for visualizing activity of claim 1, wherein the graphical representation further comprises a commerce portion, the commerce portion including at least one commercial activity segment, each commercial activity segment representing a commercial transaction portion of the node of the distributed network used by visitors to perform at least a portion of a commercial transaction using the node of the distributed network and including a representation of visitor activity relative to that commercial transaction portion of the node of the distributed network.

3. The system for visualizing activity of claim 2, wherein the at least one commercial activity segment comprises a plurality of commercial activity segments, the plurality of commercial activity segments organized into at least one group within the graphical representation.

4. The system for visualizing activity of claim 3, wherein:
the node of the distributed network is an e-commerce website on the Internet having a plurality of web pages and usable to sell a plurality of products to the visitors, each of the plurality of products associated with at least one of the plurality of web pages of the site; and
the at least one aisle of commercial activity segment comprises a buy pipeline, each of the plurality of commercial activity segments of the buy pipeline representing at least one of the web pages accessed by a visitor when purchasing at least one of the plurality of products.

5. The system for visualizing activity of claim 4, wherein, for each commercial activity segment, the representation of visitor activity comprises:
a current time segment visitor activity representation that represents visitor activity relative to the at least one represented web page for a current time period; and
a previous time segments visitor activity representation that represents visitor activity relative to the at least one represented web page for a plurality of preceding time segments.

6. The system for visualizing activity of claim 5, wherein the current time segment visitor activity representation is one of a two-dimensional object and a three-dimensional object, one of an appearance and a dimension of the current time segment visitor activity representation representing the visitor activity for the current time segment.

7. The system for visualizing activity of claim 5, wherein the previous time segment visitor activity representation is a two-dimensional object having a plurality of portions, each portion corresponding to one of the plurality of preceding time segments, one of an appearance and a dimension of that portion representing the visitor activity for the corresponding one the plurality of preceding time segments.

8. The system for visualizing activity of claim 7, wherein, for each portion of the previous time segment visitor activity representation, a dimension of that portion represents the visitor activity for the corresponding one the plurality of preceding time segments, and an appearance of that portion corresponds to a time of the corresponding one of the previous time segments prior to a time of the current time segment.

9. The system for visualizing activity of claim 3, wherein, for each commercial activity segment, the representation of visitor activity comprises:
a current time segment visitor activity representation that represents visitor activity relative to a represented commercial transaction portion of the node for a current time period; and
a previous time segments visitor activity representation that represents visitor activity relative to a represented commercial transaction portion of the node for a plurality of preceding time segments.

10. The system for visualizing activity of claim 2, wherein, for each of the at least one group, the plurality of commercial activity segments of that group are laid out within the graphical representation into at least one aisle.

11. The system for visualizing activity of claim 1, wherein the captured visitor activity relative to the node of the distributed network comprises at least one event initiated in response to actions by a visitor relative to the node of the distributed network.

12. The system for visualizing activity of claim 11, wherein each at least one event is one of a browsing event, a marketing event, a basket event, a commerce event, an auction event, an inventory event, an order processing event, an error event, a session event, a distribution event, a support event, and a scan event.

13. The system for visualizing activity of claim 1, wherein the node of the distributed network is a site on the Internet.

14. The system for visualizing activity of claim 13, wherein:
the site is an e-commerce website having a plurality of web pages and usable to sell a plurality of products to the visitors, each of the plurality of products associated with at least one of the plurality of web pages of the site; and
each of the at least one node section segment of the monitor portion represents at least one of the plurality of products and at least one web page associated with that at least one represented product and includes a representation of visitor activity relative to the at least one represented web page that is associated with that at least one represented product.

15. The system for visualizing activity of claim 14, wherein the at least one node section segment comprises a plurality of node section segments, the plurality of node section segments organized into at least one group.

16. The system for visualizing activity of claim 15, wherein, for each of the at least one group, the plurality of node section segments of that group are laid out within the graphical representation into an aisle.

17. The system for visualizing activity of claim 15, wherein:
at least one of the plurality of node section segments represents a subplurality of the plurality of products; and
in response to one of the at least one of the plurality of node section segments that represents a subplurality of the plurality of products being selected, the monitor portion further comprises a plurality of additional node section segments, each additional node section segment representing at least one of the subplurality of products, at least one web page associated with that at least one represented product and visitor activity relative to the at least one represented web page that is associated with that at least one represented product, the plurality of additional node section segments organized into an additional group.

18. The system for visualizing activity of claim 17, wherein:
the plurality of node section segments of each group are laid out within the graphical representation into an aisle; and
the plurality of additional node section segments of each additional group are laid out within the graphical representation into an additional aisle.

19. The system for visualizing activity of claim 17, wherein:
at least one of the plurality of additional node section segments represents a sub-subplurality of the subplurality of products; and
in response to one of the at least one of the plurality of additional node section segments that represents a sub-subplurality of the plurality of products being selected, the monitor portion further comprises a plurality of additional node section segments, each additional node section segment representing at least one of the sub-subplurality of products, at least one web page associated with that at least one represented product and visitor activity relative to the at least one represented web page that is associated with that at least one represented product, the plurality of additional node section segments organized into an additional group.

20. The system for visualizing activity of claim 19, wherein:
the plurality of node section segments of each group are laid out within the graphical representation into an aisle;
the plurality of additional node section segments of each additional group are laid out within the graphical representation into an additional aisle; and
the plurality of additional node section segments of each additional group of additional node section segments that represent at least one of the sub-subplurality of products are laid out within the graphical representation into another additional aisle.

21. The system for visualizing activity of claim 15, wherein:
the plurality of products is organized into a catalog;
the at least one group includes a first aisle comprising a subset of the plurality of node section segments; and
each node section segment of the first aisle corresponds to a different product category of the catalog.

22. The system for visualizing activity of claim 21, wherein:
in response to one of the node section segments of the first aisle being selected, the monitor section comprises a second aisle, the second aisle comprising a second subset of the plurality of node section segments; and
each node section segment of the second aisle corresponds to one of at least a product subcategory and a product of the catalog within the product category corresponding to the selected node section segment.

23. The system for visualizing activity of claim 15, wherein:
the at least one group includes a first aisle comprising a subset of the plurality of node section segments; and
each node section segment of the first aisle represents a different portion of the site to be monitored, each different portion comprising at least one web page of the site to be monitored.

24. The system for visualizing activity of claim 23, wherein:
in response to one of the node section segments of the first aisle being selected, the monitor section comprises a second aisle, the second aisle comprising a second subset of the plurality of node section segments; and
each node section segment of the second aisle represents a different subportion of at least one web page of the site to be monitored within the portion of the site represented by the selected node section segment.

25. The system for visualizing activity of claim 13, wherein each of the plurality of products is one of a good and a service.

26. The system for visualizing activity of claim 1, wherein, for each entry point segment and each node section segment, the representation of visitor activity comprises:
a current time segment visitor activity representation that represents visitor activity relative to the represented portion of the node for a current time period; and
a previous time segments visitor activity representation that represents visitor activity relative to the represented portion of the node for a plurality of preceding time segments.

27. The system for visualizing activity of claim 26, wherein the current time segment visitor activity representation is one of a two-dimensional object and a three-dimensional object, one of an appearance and a dimension of the current time segment visitor activity representation representing the visitor activity for the current time segment.

28. The system for visualizing activity of claim 26, wherein the previous time segment visitor activity representation is a two-dimensional object having a plurality of portions, each portion corresponding to one of the plurality of preceding time segments, one of an appearance and a dimension of that portion representing the visitor activity for the corresponding one the plurality of preceding time segments.

29. The system for visualizing activity of claim 28, wherein, for each portion of the previous time segment visitor activity representation, a dimension of that portion represents the visitor activity for the corresponding one the plurality of preceding time segments, and an appearance of that portion corresponds to a time of the corresponding one of the previous time segments prior to a time of the current time segment.

30. The system for visualizing activity of claim 1, wherein the activity visualization system further comprises at least one two-dimensional graphical representation of the captured visitor activity.

31. The system for visualizing activity of claim 1, wherein the graphical representation further comprises a plurality of motion indicators that represent movement of visitors between portions of the node of the distributed network corresponding to the at least one entry point segment and the at least one node section segment displayed in the entry portion and the monitored portion.

32. The system for visualizing activity of claim 31, wherein each of the plurality of motion indicators comprises one of a two-dimensional motion indicator object and a three-dimensional motion indicator object, each motion indicator object associated with a source portion of the node and a destination portion of the node, one of an appearance and a dimension of that motion indicator object representing an amount of visitor movement between the source portion of the node for that motion indicator object and a destination portion of the node for that motion indicator object.

33. The system for visualizing activity of claim 324, wherein, for each of the plurality of motion indicator objects, the graphical representation further comprises a path representation extending between a source segment of the at least one entry point segment and the at least one node section segment displayed in the entry portion and the monitored portion corresponding to the source portion of the node for that motion indicator object and a destination segment of the at least one entry point segment and the at least one node section segment displayed in the entry portion and the monitored portion corresponding to the destination portion of the node for that motion indicator object.

34. The system for visualizing activity of claim 33, wherein, in response to the graphical representation being updated based on visitor activity within a current time period from visitor activity within a previous time period, each of the plurality of motion indicator objects moves along the path representation for that motion indicator object from the source segment for that motion indicator object to the destination segment for that motion indicator object.

35. The system for visualizing activity of claim 1, wherein the activity visualization system generates the graphical representation based on the captured visitor activity in substantially real time, such that the graphical representation represents the captured visitor activity as the visitor activity occurs and is captured.

36. A method for visualizing activity on a node of a distributed network, comprising:
capturing visitor activity relative to the node of the distributed network;
representing the captured visitor activity using a graphical representation, comprising:
representing each of at least one portion of the node of the distributed network used by visitors to enter the node of the distributed network and visitor activity relative to that portion of the node of the distributed network using an entry point segment; and
representing each of at least one portion of the node of the distributed network and visitor activity relative to that portion of the node of the distributed network using a node section segment; and
displaying the graphical representation to a user.

37. The method of claim 36, wherein the captured visitor activity relative to the node of the distributed network comprises at least one event initiated in response to actions by a visitor relative to the node of the distributed network.

38. The method of claim 36, wherein each at least one event is one of a browsing event, a marketing event, a basket event, a commerce event, an auction event, an inventory event, an order processing event, an error event, a session event, a distribution event, a support event, and a scan event.

39. The method of claim 36, wherein representing the captured visitor activity using at least the graphical representation further comprises representing each of at least one commercial transaction portion of the node of the distributed network used by visitors to perform at least a portion of a commercial transaction using the node of the distributed network and visitor activity relative to that commercial transaction portion of the node of the distributed network using a commercial activity segment.

40. The method of claim 39, wherein displaying the at least one commercial activity segment comprises displaying the at least one commercial activity segment in at least one group.

41. The method of claim 40, wherein displaying the at least one commercial activity segment in at least one group comprises displaying, for each of the at least one group, the plurality of commercial activity segments of that group in at least one aisle within the graphical representation.

42. The method of claim 40, wherein:
the node of the distributed network is an e-commerce website having a plurality of web pages and usable to sell a plurality of products to the visitors, each of the plurality of products associated with at least one of the plurality of web pages of the site; and
the at least one aisle of at least one commercial activity segment comprises a buy pipeline, each of the plurality of commercial activity segments of the buy pipeline representing at least one of the web pages accessed by a visitor when purchasing at least one of the plurality of products.

43. The method of claim 42, wherein representing the visitor activity represented by each commercial activity segment comprises:
representing visitor activity relative to the at least one represented web page for a current time period using a current time segment visitor activity representation; and
representing visitor activity relative to the at least one represented web page for a plurality of preceding time segments using a previous time segments visitor activity representation.

44. The method of claim 43, wherein:
the current time segment visitor activity representation is one of a two-dimensional object and a graphical object; and
representing the visitor activity for the current time segment comprises altering one of an appearance and a dimension of the current time segment visitor activity representation based on the visitor activity for the current time period relative to the represented commercial transaction portion of the node.

45. The method of claim 43, wherein:
the previous time segment visitor activity representation is a two-dimensional object having a plurality of portions; and
representing, for each of the plurality of preceding time segments, the visitor activity for that preceding time segments comprises altering one of an appearance and a dimension of the portion of the two-dimensional object corresponding to that preceding time segment based on the visitor activity for that preceding time period relative to the at least one represented web page.

46. The method of claim 45, wherein:
representing, for each of the plurality of preceding time segments, the visitor activity for that preceding time segments comprises altering a dimension of the portion of the two-dimensional object corresponding to that preceding time segment based on the visitor activity for that preceding time period relative to (the represented commercial transaction portion of the node/ the at least one represented web page); and
representing, for each of the plurality of preceding time segments, a time of that previous time segment prior to a time of the current time segment comprises altering an appearance of that portion of the two-dimensional object.

47. The method of claim 40, wherein representing the visitor activity represented by each commercial activity segment comprises:
representing visitor activity relative to a represented commercial transaction portion of the node for a current time period using a current time segment visitor activity representation; and
representing visitor activity relative to a represented commercial transaction portion of the node for a plurality of preceding time segments using a previous time segments visitor activity representation.

48. The method of claim 36, wherein the node of the distributed network is a site on the Internet.

49. The method of claim 48, wherein:
the site is an e-commerce website having a plurality of web pages and usable to sell a plurality of products to the visitors, each of the plurality of products associated with at least one of the plurality of web pages of the site; and
each of the at least one node section segment represents at least one of the plurality of products, at least one web page associated with that at least one represented product and visitor activity relative to the at least one represented web page that is associated with that at least one represented product.

50. The method of claim 49, wherein:
the at least one node section segment comprises a plurality of node section segments; and
displaying the graphical representation comprises displaying the plurality of node section segments in at least one group.

51. The method of claim 50, wherein displaying the at least one node section segment in at least one group comprises displaying, for each of the at least one group, the plurality of node section segments of that group in at least one aisle within the graphical representation.

52. The method of claim 50, wherein:
at least one of the plurality of node section segments represents a subplurality of the plurality of products;
representing each of at least one portion of the node of the distributed network and visitor activity relative to that portion of the node of the distributed network using a node section segment comprises representing, for each such node section segment, the subplurality of products corresponding to that node section segment using a plurality of additional node section segments, each additional node section segment representing at least one of the subplurality of products, at least one web page associated with that at least one represented product and visitor activity relative to the at least one represented web page that is associated with that at least one represented product;
the method further comprises selecting one of the at least one of the plurality of node section segments that represents a subplurality of the plurality of products; and
displaying the plurality of node section segments in at least one group further comprises, in response to selecting one of the node section segments that represents a subplurality of the plurality of products, displaying, in an additional group, the plurality of additional node section segments that represent the subplurality of the plurality of products corresponding to the selected node section segment.

53. The method of claim 52, wherein displaying the at least one node section segment in at least one group comprises:
displaying, for each of the at least one group, the plurality of node section segments of that group in at least one aisle within the graphical representation; and
displaying the plurality of additional node section segments of the additional group in an additional aisle within the graphical representation.

54. The method of claim 52, wherein:
at least one of the plurality of additional node section segments represents a sub-subplurality of the subplurality of products; and
representing each of at least one portion of the node of the distributed network and visitor activity relative to that portion of the node of the distributed network using a node section segment comprises representing, for each such additional node section segment, the sub-subplurality of products corresponding to that additional node section segment using a plurality of additional node section segments, each additional node section segment representing at least one of the sub-subplurality of products, at least one web page associated with that at least one represented product and visitor activity relative to the at least one represented web page that is associated with that at least one represented product; and
the method further comprises selecting one of the at least one of the plurality of additional node section segments that represents a sub-subplurality of the plurality of products; and
displaying the plurality of node section segments in at least one aisle further comprises, in response to selecting one of the additional node section segments, displaying, in an additional aisle, the plurality of additional node section segments that represent the sub-subplurality of the plurality of products corresponding to the selected additional node section segment.

55. The method of claim 54, wherein displaying the at least one node section segment in at least one group comprises:
displaying, for each of the at least one group, the plurality of node section segments of that group in at least one aisle within the graphical representation;
displaying the plurality of additional node section segments that represent the subplurality of the plurality of products in an additional aisle within the graphical representation; and
displaying the plurality of additional node section segments that represent the sub-subplurality of the plurality of products in an additional aisle within the graphical representation.

56. The method of claim 50, wherein:
the plurality of products is organized into a catalog having a plurality of product categories;
representing each of at least one portion of the node of the distributed network and visitor activity relative to that portion of the node of the distributed network using a node section segment comprises representing each of the plurality of product categories using a different one of a subset of the node section segments, each different node section segment representing one of the product categories, at least one web page associated with the represented product category and visitor activity relative to the at least one represented web page that is associated with the represented product category; and
displaying the plurality of node section segments in at least one group comprises displaying the subset of node section segments in a first aisle.

57. The method of claim 56, wherein:
each of the plurality of product categories of the catalog comprises at least two of at least one subcategory and at least one product within that product category;
representing each of at least one portion of the node of the distributed network and visitor activity relative to that portion of the node of the distributed network using a node section segment further comprises representing, for each of the plurality of product categories, the at least two of at least one subcategory and at least one product within that product category using a different one of a second subset of the node section segments corresponding to that product category, each different node section segment representing one of the at least two of at least one subcategory and at least one product, at least one web page associated with each represented subcategory or product and visitor activity relative to the at least one represented web page that is associated with the represented subcategory or product; and
the method further comprises selecting one of the node section segments of the first aisle; and
displaying the plurality of node section segments in at least one group further comprises, in response to selecting one of the node section segments of the first aisle, displaying the second subset of the plurality of node section segments corresponding to the selected node section segment in a second group.

58. The method of claim 50, wherein:
displaying the plurality of node section segments in at least one group comprises displaying a first aisle comprising a subset of the plurality of node section segments; and
each node section segment of the first aisle represents a different portion of the site to be monitored, each different portion comprising at least one web page of the site to be monitored.

59. The method of claim 58, further comprising selecting one of the node section segments of the first aisle, wherein:
displaying the graphical representation further comprises, in response to selecting one of the node section segments of the first aisle, displaying a second aisle comprising a second subset of the plurality of node section segments; and
each node section segment of the second aisle represents a different subportion of at least one web page of the site to be monitored within the portion of the site represented by the selected node section segment.

60. The method of claim 36, wherein representing each of at least one portion of the node of the distributed network used by visitors to enter the node of the distributed network and visitor activity relative to that portion of the node of the distributed network using an entry point segment and representing each of at least one portion of the node of the distributed network and visitor activity relative to that portion of the node of the distributed network using a node section segment each comprises:
representing visitor activity relative to the represented portion of the node for a current time period using a current time segment visitor activity representation; and
representing visitor activity relative to the represented portion of the node for a plurality of preceding time segments using a previous time segments visitor activity representation.

61. The method of claim 60, wherein:
the current time segment visitor activity representation comprises one of a two-dimensional object and a three-dimensional object; and
representing visitor activity relative to the represented portion of the node for the current time period using the current time segment visitor activity representation comprises representing visitor activity relative to the represented portion of the node for the current time period using one of an appearance and a dimension of the one of the two-dimensional object and the three-dimensional object.

62. The method of claim 60, wherein:
the previous time segment visitor activity representation comprises a two-dimensional object having a plurality of portions; and
representing visitor activity relative to the represented portion of the node for the plurality of preceding time segments using the previous time segments visitor activity representation comprises representing visitor activity relative to the represented portion of the node for the plurality of preceding time segments using one of an appearance and a dimension of the two-dimensional object.

63. The method of claim 62, wherein representing visitor activity relative to the represented portion of the node for the plurality of preceding time segments using one of an appearance and a dimension of the two-dimensional object comprises:
representing, for each of the plurality of portions, the visitor activity corresponding to that portion using a dimension of that portion; and
representing, for each of the plurality of portions, a time of that portions prior to a time of the current time segment using an appearance of that portion.

64. The method of claim 36, further comprising displaying at least one two-dimensional graphical representation of the captured visitor activity.

65. The method of claim 36, wherein representing the captured visitor activity using a graphical representation further comprises representing movement of visitors between portions of the node of the distributed network corresponding to the at least one entry point segment and the at least one node section segment displayed in the entry portion and the monitored portion using a plurality of motion indicators.

66. The method of claim 65, wherein:
each of the plurality of motion indicators comprises one of a two-dimensional motion indicator object and a three-dimensional motion indicator object; and
representing movement of visitors using the plurality of motion indicators comprises:
associating each motion indicator object with a source portion of the node and a destination portion of the node, and representing an amount of visitor movement between the source portion of the node for that motion indicator object and a destination portion of the node for that motion indicator object using one of an appearance and a dimension of that motion indicator object.

67. The method of claim 66, wherein displaying the graphical representation to a user further comprises:
displaying, for each motion indicator object, a corresponding path representation extending between a source segment of the at least one entry point segment and the at least one node section segment displayed in the entry portion and the monitored portion corresponding to the source portion of the node for that motion indicator object and a destination segment of the at least one entry point segment and the at least one node section segment displayed in the entry portion and the monitored portion corresponding to the destination portion of the node for that motion indicator object; and
in response to the graphical representation being updated based on visitor activity within a current time period from visitor activity within a previous time period, moving, for each motion indicator object, that motion indicator object along the corresponding path representation.

68. The method of claim 36, wherein representing the captured visitor activity using a graphical representation comprises generating the graphical representation based on the captured visitor activity in substantially real time, such that the graphical representation represents the captured visitor activity as the visitor activity occurs and is captured.

69. A system for visualizing movement of visitors to a node of a distributed network between portions of the node, comprising:
an activity monitoring system usable to capture visitor activity relative to the node of the distributed network; and
an activity visualization system that generates a graphical representation based on the captured visitor activity, the graphical representation comprising:
a plurality of node segments, each node section segment representing one of the portions of the node and including a representation of visitor activity relative to that portion of the node of the distributed network, and a plurality of motion indicators that represent movement of visitors between the portions of the node corresponding to the node segments.

70. The system for visualizing movement of claim 69, wherein each of the plurality of motion indicators comprises one of a two-dimensional motion indicator object and a three-dimensional motion indicator object, each motion indicator object associated with a source portion of the node and a destination portion of the node, one of an appearance and a dimension of that motion indicator object representing an amount of visitor movement between the source portion of the node for that motion indicator object and a destination portion of the node for that motion indicator object.

71. The system for visualizing movement of claim 70, wherein, for each of the plurality of motion indicator objects, the graphical representation further comprises a path representation extending between a source segment of the node segments corresponding to the source portion of the node for that motion indicator object and a destination segment of the node segments corresponding to the destination portion of the node for that motion indicator object.

72. The system for visualizing movement of claim 69, wherein, in response to the graphical representation being updated based on visitor activity within a current time period from visitor activity within a previous time period, each of the plurality of motion indicator objects moves along the path representation for that motion indicator object from the source segment for that motion indicator object to the destination segment for that motion indicator object.

73. The system for visualizing movement of claim 69, wherein the captured visitor activity relative to the node of the distributed network comprises at least one event initiated in response to actions by a visitor relative to the node of the distributed network.

74. The system for visualizing movement of claim 69, wherein each at least one event is one of a browsing event, a marketing event, a basket event, a commerce event, an auction event, an inventory event, an order processing event, an error event, a session event, a distribution event, a support event, and a scan event.

75. The system for visualizing movement of claim 69, wherein the activity visualization system generates the graphical representation based on the captured visitor activity in substantially real time, such that the graphical representation represents the captured visitor activity as the visitor activity occurs and is captured.

76. A method for visualizing movement of visitors to a node of a distributed network between portions of the node, comprising:
capturing visitor activity relative to the node of the distributed network;
representing the captured visitor activity using a graphical representation, comprising:
representing each of at least one portion of the node of the distributed network and visitor activity relative to that portion of the node of the distributed network using a node segment; and
representing movement of visitors between the portions of the node corresponding to the node segments using a plurality of motion indicators; and
displaying the graphical representation to a user.

77. The method of claim 76, wherein:
each of the plurality of motion indicators comprises one of a two-dimensional motion indicator object and a three-dimensional motion indicator object; and
representing movement of visitors using the plurality of motion indicators comprises:
associating each motion indicator object with a source portion of the node and a destination portion of the node, and
representing an amount of visitor movement between the source portion of the node for that motion indicator object and a destination portion of the node for that motion indicator object using one of an appearance and a dimension of that motion indicator object.

78. The method of claim 77, wherein displaying the graphical representation to a user further comprises:
displaying, for each motion indicator object, a corresponding path representation extending between a source segment of the node segments corresponding to the source portion of the node for that motion indicator object and a destination segment of the node segments corresponding to the destination portion of the node for that motion indicator object; and
in response to the graphical representation being updated based on visitor activity within a current time period from visitor activity within a previous time period, moving, for each motion indicator object, that motion indicator object along the corresponding path representation.

79. The method of claim 76, wherein the captured visitor activity relative to the node of the distributed network comprises at least one event initiated in response to actions by a visitor relative to the node of the distributed network.

80. The method of claim 79, wherein each at least one event is one of a browsing event, a marketing event, a basket event, a commerce event, an auction event, an inventory event, an order processing event, an error event, a session event, a distribution event, a support event, and a scan event.

81. The method of claim 76, wherein representing the captured visitor activity using a graphical representation comprises generating the graphical representation based on the captured visitor activity in substantially real time, such that the graphical representation represents the captured visitor activity as the visitor activity occurs and is captured.

82. A system for visualizing historical trends of activity on a node of a distributed network, comprising:
an activity monitoring system usable to capture visitor activity relative to the node of the distributed network; and
an activity visualization system that generates a graphical representation based on the captured visitor activity, the graphical representation comprising:
a plurality of node segments, each node section segment representing one of the portions of the node; and
for each of the plurality of node segments, a representation of visitor activity relative to that portion of the node of the distributed network, comprising:
a current time segment visitor activity representation that represents visitor activity relative to the represented portion of the node for a current time period; and
a previous time segments visitor activity representation that represents visitor activity relative to the represented portion of the node for a plurality of preceding time segments.

83. The system for visualizing historical trends of claim 82, wherein the current time segment visitor activity representation is one of a two-dimensional object and a three-dimensional object, one of an appearance and a dimension of the current time segment visitor activity representation representing the visitor activity for the current time segment.

84. The system for visualizing historical trends of claim 82, wherein the previous time segment visitor activity representation is a two-dimensional object having a plurality of portions, each portion corresponding to one of the plurality of preceding time segments, one of an appearance and a dimension of that portion representing the visitor activity for the corresponding one the plurality of preceding time segments.

85 The system for visualizing historical trends of claim 84, wherein, for each portion of the previous time segment visitor activity representation, a dimension of that portion represents the visitor activity for the corresponding one the plurality of preceding time segments, and an appearance of that portion corresponds to a time of the corresponding one of the previous time segments prior to a time of the current time segment.

86. The system for visualizing historical trends of claim 82, wherein the captured visitor activity relative to the node of the distributed network comprises at least one event initiated in response to actions by a visitor relative to the node of the distributed network.

87. The system for visualizing historical trends of claim 82, wherein each at least one event is one of a browsing event, a marketing event, a basket event, a commerce event, an auction event, an inventory event, an order processing event, an error event, a session event, a distribution event, a support event, and a scan event.

88. The system for visualizing historical trends of claim 82, wherein the activity visualization system generates the graphical representation based on the captured visitor activity in substantially real time, such that the graphical representation represents the captured visitor activity as the visitor activity occurs and is captured.

89. A method for visualizing historical trends of activity on a node of a distributed network, comprising:
capturing visitor activity relative to the node of the distributed network;
representing each of at least one portion of the node of the distributed network and captured visitor activity relative to that portion of the node of the distributed network using a node segment, comprising:
representing visitor activity relative to the represented portion of the node for a current time period using a current time segment visitor activity representation, and
representing visitor activity relative to the represented portion of the node for a plurality of preceding time segments using a previous time segments visitor activity representation;
displaying the node segments for the at least one portion of the node to a user; and
displaying, within each node segment, the current time segment visitor activity representation and the previous time segments visitor activity representation for the portion of the node represented by that node segment.

90. The method of claim 89, wherein:
the current time segment visitor activity representation comprises one of a two-dimensional object and a three-dimensional object; and
representing visitor activity relative to the represented portion of the node for the current time period using the current time segment visitor activity representation comprises representing visitor activity relative to the represented portion of the node for the current time period using one of an appearance and a dimension of the one of the two-dimensional object and the three-dimensional object.

91. The method of claim 89, wherein:
the previous time segment visitor activity representation comprises a two-dimensional object having a plurality of portions; and
representing visitor activity relative to the represented portion of the node for the plurality of preceding time segments using the previous time segments visitor activity representation comprises representing visitor activity relative to the represented portion of the node for the plurality of preceding time segments using one of an appearance and a dimension of the two-dimensional object.

92. The method of claim 91, wherein representing visitor activity relative to the represented portion of the node for the plurality of preceding time segments using one of an appearance and a dimension of the two-dimensional object comprises:
representing, for each of the plurality of portions, the visitor activity corresponding to that portion using a dimension of that portion; and
representing, for each of the plurality of portions, a time of that portions prior to a time of the current time segment using an appearance of that portion.

93. The method of claim 89, wherein the captured visitor activity relative to the node of the distributed network comprises at least one event initiated in response to actions by a visitor relative to the node of the distributed network.

94. The method of claim 93, wherein each at least one event is one of a browsing event, a marketing event, a basket event, a commerce event, an auction event, an inventory event, an order processing event, an error event, a session event, a distribution event, a support event, and a scan event.

95. The method of claim 89, wherein representing the captured visitor activity using a graphical representation comprises generating the graphical representation based on the captured visitor activity in substantially real time, such that the graphical representation represents the captured visitor activity as the visitor activity occurs and is captured.
